(19) United States
(12) Patent Application Publication
(10) Pub. No.: US 2025/0244688 A1
(43) Pub. Date: Jul. 31, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Ryosuke FUJII, Kanagawa (JP); Tomoya SASAKI, Kanagawa (JP); Yuto OKAZAKI, Kanagawa (JP); Makoto YABE, Kanagawa (JP); Kosuke NARITA, Kanagawa (JP)

(73) Assignee: FUJIFILM Business Innovation Corp., Tokyo (JP)

(21) Appl. No.: 18/791,621

(22) Filed: Aug. 1, 2024

(30) Foreign Application Priority Data
Jan. 25, 2024 (JP) 2024-009754

(51) Int. Cl. G03G 5/05

(52) U.S. Cl. CPC G03G 5/0564; G03G 5/056

(57) ABSTRACT

An electrophotographic photoreceptor includes: a conductive substrate; and a multilayer-type photosensitive layer that is disposed on the conductive substrate and has a charge generation layer and a charge transport layer. The charge transport layer contains a charge-transporting material and at least one of a polyester resin and a polycarbonate resin that each have a structural unit including a biphenyl represented by formula (1). The charge transport layer has an acid value of 2 mgKOH/g or less.

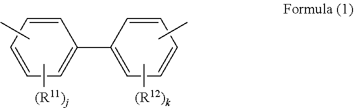

In formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

### CROSS-REFERENCE TO RELATED APPLICATIONS

This application is based on and claims priority under 35 USC 119 from Japanese Patent Application No. 2024-009754 filed Jan. 25, 2024.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2014-209221 discloses an electrophotographic photoreceptor that has at least a photosensitive layer on a conductive support, wherein the photosensitive layer contains a triphenylamine compound and a polyarylate resin having a carboxylic acid terminal value of 100 equivalent/g or more and 500μ equivalent/g or less.

Japanese Unexamined Patent Application Publication No. 2023-121554 discloses an electrophotographic photoreceptor including a conductive substrate and a multilayer-type photosensitive layer that has a charge generation layer and a charge transport layer, wherein the charge transport layer contains a charge-transporting material, at least one of a polyester resin having a structural unit with an aromatic ring and a polycarbonate resin having a structural unit with an aromatic ring, and a compound represented by a predetermined chemical formula and having a melting point of 40° C. or higher.

### SUMMARY

Aspects of non-limiting embodiments of the present disclosure relate to an electrophotographic photoreceptor that has high wear resistance and is less subject to filming.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspects. The formulas are the same as the formulas with the same corresponding numbers described below.

According to an aspect of the present disclosure, there is provided an electrophotographic photoreceptor including:
a conductive substrate; and
a multilayer-type photosensitive layer that is disposed on the conductive substrate and has a charge generation layer and a charge transport layer,
wherein the charge transport layer contains a charge-transporting material and at least one of a polyester resin and a polycarbonate resin that each have a structural unit including a biphenyl represented by formula (1), and
the charge transport layer has an acid value of 2 mgKOH/g or less:

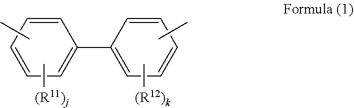

in formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

### BRIEF DESCRIPTION OF THE DRAWINGS

Exemplary embodiments of the present disclosure will be described in detail based on the following figures, wherein:

FIG. 1 is a partial cross-sectional view of an example of the layer structure of an electrophotographic photoreceptor according to a first exemplary embodiment;

FIG. 2 is a partial cross-sectional view of an example of the layer structure of an electrophotographic photoreceptor according to a second exemplary embodiment;

FIG. 3 is a schematic structural view of one example of an image forming apparatus according to the present exemplary embodiment; and

FIG. 4 is a schematic structural view of another example of the image forming apparatus according to the present exemplary embodiment.

### DETAILED DESCRIPTION

Exemplary embodiments of the present disclosure will be described below. The following description and Examples are for illustrating the exemplary embodiments, and are not intended to limit the scope of the exemplary embodiments.

A numerical range expressed by using “to” in the present disclosure indicates a range including the values before and after “to” as the minimum value and the maximum value.

With regard to numerical ranges described stepwise in the present disclosure, the upper limit or the lower limit of one numerical range may be replaced by the upper limit or the lower limit of other numerical ranges described stepwise. The upper limit or lower limit of any numerical range described in the present disclosure may be replaced by a value described in Examples.

The phase “A and/or B” in the present disclosure has the same meaning as the phrase “at least one of A and B.” In other words, the phrase “A and/or B” means only A, only B, or a combination of A and B.

In the present disclosure, the term “step” includes not only an independent step but also a step that cannot be clearly distinguished from other steps but may accomplish the purpose of the step.

In the description of exemplary embodiments with reference to the drawings in the present disclosure, the configurations according to the exemplary embodiments are not limited to the configurations illustrated in the drawings. The sizes of members in each figure are schematic, and the relative relationship between the sizes of the members is not limited to what is illustrated.

In the present disclosure, each component may include two or more corresponding substances. In the present disclosure, the amount of each component in a composition refers to, when there are two or more substances corresponding to each component in the composition, the total amount of the substances present in the composition, unless otherwise specified.

In the present disclosure, each component may include two or more types of particles corresponding to each component. The particle size of each component refers to, when there are two or more types of particles corresponding to each component in the composition, the particle size of a mixture of two or more types of particles present in the composition, unless otherwise specified.

In the present disclosure, alkyl groups and alkylene groups include linear, branched, and cyclic groups, unless otherwise specified.

In the present disclosure, hydrogen atoms in organic groups, aromatic rings, linking groups, alkyl groups, alkylene groups, aryl groups, aralkyl groups, alkoxy groups, aryloxy groups, and other groups may be substituted by halogen atoms.

To express compounds by structural formulas in the present disclosure, compounds may be represented by structural formulas without symbols (C and H) representing carbon and hydrogen atoms in hydrocarbon groups and/or hydrocarbon chains.

In the present disclosure, the “structural unit” of a copolymer or resin has the same meaning as a monomer unit.

### Electrophotographic Photoreceptor

In the present disclosure, a first exemplary embodiment and a second exemplary embodiment are provided as electrophotographic photoreceptors (hereinafter also referred to as “photoreceptors”).

A photoreceptor according to the first exemplary embodiment includes: a conductive substrate; and a multilayer-type photosensitive layer that is disposed on the conductive substrate and has a charge generation layer and a charge transport layer. The photoreceptor according to the first exemplary embodiment may further include other layers (e.g., undercoat layer, intermediate layer).

A photoreceptor according to the second exemplary embodiment includes: a conductive substrate; and a single layer type photosensitive layer disposed on the conductive substrate. The photoreceptor according to the second exemplary embodiment may further include other layers (e.g., undercoat layer, intermediate layer).

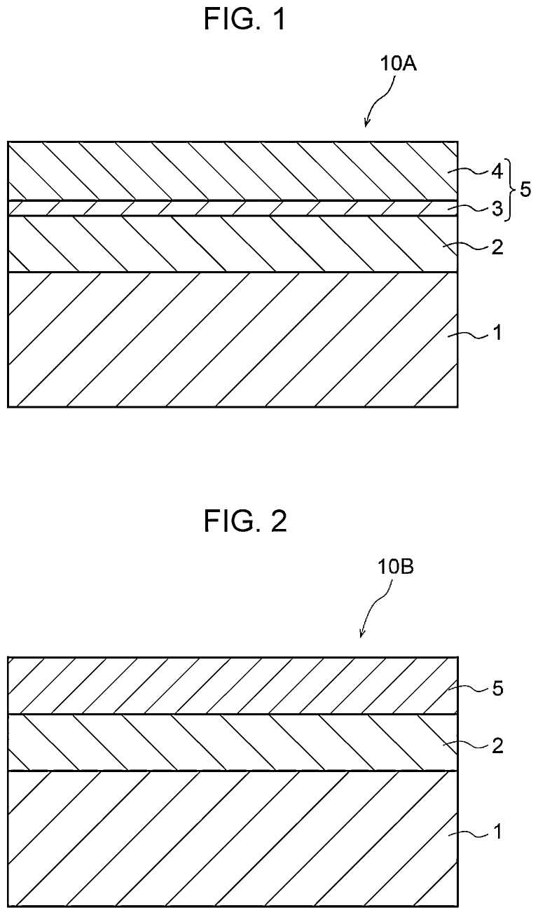

FIG. 1 is a partial cross-sectional view schematically illustrating an example of the layer structure of the photoreceptor according to the first exemplary embodiment. Referring to FIG. 1, a photoreceptor 10A has a multilayer-type photosensitive layer. The photoreceptor 10A includes an undercoat layer 2, a charge generation layer 3, and a charge transport layer 4 in this order on a conductive substrate 1. The charge generation layer 3 and the charge transport layer 4 constitute a photosensitive layer 5 (so-called layered photosensitive layer). The photoreceptor 10A may have an intermediate layer (not shown) between the undercoat layer 2 and the charge generation layer 3. The undercoat layer 2 is an optional layer.

FIG. 2 is a partial cross-sectional view schematically illustrating an example of the layer structure of the photoreceptor according to the second exemplary embodiment. Referring to FIG. 2, a photoreceptor 10B has a single layer type photosensitive layer. In the photoreceptor 10B, an undercoat layer 2 and a photosensitive layer 5 are stacked in this order on a conductive substrate 1. The photoreceptor 10B may have an intermediate layer (not shown) between the undercoat layer 2 and the photosensitive layer 5. The undercoat layer 2 is an optional layer.

In the photoreceptor according to the first exemplary embodiment, the charge transport layer contains a charge-transporting material and at least one of a polyester resin and a polycarbonate resin that each have a structural unit including a biphenyl represented by formula (1), and the charge transport layer has an acid value of 2 mgKOH/g or less.

In the photoreceptor according to the second exemplary embodiment, the single layer type photosensitive layer contains a charge-transporting material and at least one of a polyester resin and a polycarbonate resin that each have a structural unit including a biphenyl represented by formula (1), and the single layer type photosensitive layer has an acid value of 2 mgKOH/g or less.

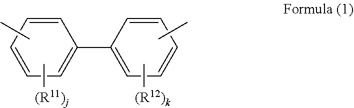

In formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

The biphenyl represented by formula (1) may be the whole structure or part of the structure obtained by removing ester bonds (—C(═O)O—) or carbonate bonds (—OC(═O)O—) from the structural unit including the biphenyl represented by formula (1). In other words, the right and left ends of the biphenyl represented by formula (1) may each independently be bonded directly to an ester bond or a carbonate bond, or bonded to an ester bond or a carbonate bond with another atom or an atomic group therebetween.

In the description of matters common to the first exemplary embodiment and the second exemplary embodiment, both exemplary embodiments are collectively referred to below as the present exemplary embodiment.

A photoreceptor according to the present exemplary embodiment has high wear resistance and is less subject to filming. The mechanism for this is assumed as described below. In the following description, the charge transport layer in the multilayer-type photosensitive layer and the single layer type photosensitive layer are collectively referred to as “photosensitive layer”.

In the photosensitive layer containing, as a binder resin, at least one of the polyester resin and the polycarbonate resin that each have a structural unit including the biphenyl represented by formula (1), the cohesion force between the molecules of the binder resin is strong due to the stacking effect of the molecules of the biphenyl represented by formula (1) so that the photosensitive layer has improved wear resistance.

The photosensitive layer with high wear resistance may prevent the photoreceptor surface from being refreshed and may cause attachment of toner components on the photoreceptor surface to cause filming.

The photoreceptor according to the present exemplary embodiment is less prone to the attachment of substances that react with acid groups or are attracted to acid groups when the photosensitive layer has a low acid value, that is, the photosensitive layer has a low acid group content. As a result, the photoreceptor surface may be less subject to filming.

In the photoreceptor according to the first exemplary embodiment, the acid value of the charge transport layer is preferably as low as possible to prevent or reduce generation of filming. The acid value of the charge transport layer is 2 mgKOH/g or less, preferably 1.5 mgKOH/g or less, more preferably 1 mgKOH/g or less.

In the photoreceptor according to the second exemplary embodiment, the acid value of the single layer type photosensitive layer is preferably as low as possible to prevent or reduce generation of filming. The acid value of the single layer type photosensitive layer is 2 mgKOH/g or less, preferably 1.5 mgKOH/g or less, more preferably 1 mgKOH/g or less.

The acid value of the charge transport layer or the single layer type photosensitive layer is adjusted by, for example, the following methods.

Examples of the methods include using an appropriate amount of terminal capping agent when synthesizing a polyester resin or a polycarbonate resin used as a binder resin in the charge transport layer or the single layer type photosensitive layer; increasing the purity of the monomers used as raw materials; starting the polymerization reaction after dissolving the monomers well; and setting, at a low level, the concentration of dicarboxylic acid (specifically, dicarboxylic acid chloride) or phosgene in the polymerization reaction system.

The acid value of the charge transport layer or the single layer type photosensitive layer is measured as described below. In the following description, the charge transport layer in the multilayer-type photosensitive layer and the single layer type photosensitive layer are collectively referred to as “photosensitive layer”.

The photosensitive layer is peeled off from the photoreceptor and weighed precisely to 500 mg. The photosensitive layer (500 mg) and tetrahydrofuran (20 ml) are mixed and stirred well so that the components of the photosensitive layer are dissolved or dispersed in tetrahydrofuran. The resulting dispersion or solution is used as a titration sample. By using an automatic potentiometric titrator, 0.01 mL aliquots of 0.005 mol/L potassium hydroxide-isopropyl alcohol solution are added dropwise to the titration sample to determine a titration curve. The inflection point of the titration curve is set as an endpoint, and the titration volume up to the endpoint is calculated. The acid value (mgKOH/g) of the photosensitive layer is calculated from the titration volume and the mass (500 mg) of the photosensitive layer subjected to titration.

The polyester resin and the polycarbonate resin that each have a structural unit including the biphenyl represented by formula (1) will be described below in detail.

### Polyester Resin (1)

In the present disclosure, the polyester resin that has a structural unit including the biphenyl represented by formula (1) is referred to as polyester resin (1).

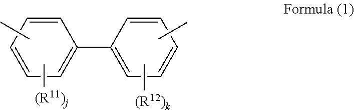

In formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

j is an integer of 0 or more and 4 or less, preferably an integer of 0 or more and 3 or less, more preferably an integer of 0 or more and 2 or less, still more preferably 0 or 1, yet still more preferably 0.

When j is an integer of 1 or more, j R¹¹'s are each independently a methyl group or an ethyl group, preferably a methyl group.

k is an integer of 0 or more and 4 or less, preferably an integer of 0 or more and 3 or less, more preferably an integer of 0 or more and 2 or less, still more preferably 0 or 1, yet still more preferably 0.

When k is an integer of 1 or more, k R¹²'s are each independently a methyl group or an ethyl group, preferably a methyl group.

To provide a structural unit including the biphenyl represented by formula (1) in molecules, the polyester resin (1) preferably has at least one of a dicarboxylic acid unit (1-A) represented by formula (1-A) and a diol unit (1-B) represented by formula (1-B), more preferably has a dicarboxylic acid unit (1-A) represented by formula (1-A).

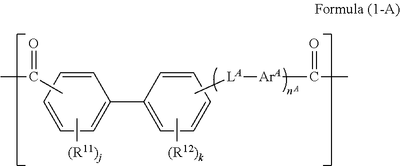

In formula (1-A), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{A} is a single bond or a divalent linking group, Ar^{A} is an optionally substituted aromatic ring, and n^{A} is 0, 1, or 2.

j, k, R¹¹, and R¹² in formula (1-A) respectively have the same definitions as j, k, R¹¹, and R¹² in formula (1) and also respectively have the same specific forms and the same suitable forms as j, k, R¹¹, and R¹² in formula (1).

When L^{A} is a divalent linking group, the divalent linking group is, for example, an oxygen atom, a sulfur atom, or —C(Ra¹)(Ra²)—. Ra¹ and Ra² are each independently a hydrogen atom, a C1-C10 alkyl group, a C6-C12 aryl group, or a C7-C20 aralkyl group, and Ra¹ and Ra² taken together may form a cyclic alkyl group.

The C1-C10 alkyl groups represented by Ra¹ and Ra² may be linear, branched, or cyclic. The number of carbon atoms in the alkyl groups is preferably 1 or more and 6 or less, more preferably 1 or more and 4 or less, still more preferably 1 or 2.

The C6-C12 aryl groups represented by Ra¹ and Ra² may be monocyclic or polycyclic. The number of carbon atoms in the aryl groups is preferably 6 or more and 10 or less, more preferably 6.

The alkyl group in the C7-C20 aralkyl groups represented by Ra¹ and Ra² may be linear, branched, or cyclic. The number of carbon atoms in the alkyl group in the C7-C20 aralkyl groups is preferably 1 or more and 4 or less, more preferably 1 or more and 3 or less, still more preferably 1 or 2.

The aryl group in the C7-C20 aralkyl groups represented by Ra¹ and Ra² may be monocyclic or polycyclic. The number of carbon atoms in the aryl groups is preferably 6 or more and 10 or less, more preferably 6.

The aromatic ring Ar^{A} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{A} may be substituted by alkyl groups, aryl groups, aralkyl groups, alkoxy groups, aryloxy groups, and halogen atoms. The substituents by which the aromatic ring Ar^{A} is substituted may be C1-C10 alkyl groups, C6-C12 aryl groups, and C1-C6 alkoxy groups.

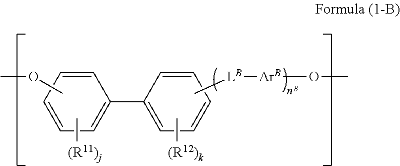

In formula (1-B), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{B} is a single bond or a divalent linking group, Ar^{B} is an optionally substituted aromatic ring, and n^{B} is 0, 1, or 2.

j, k, R¹¹, and R¹² in formula (1-B) respectively have the same definitions as j, k, R¹¹, and R¹² in formula (1) and also respectively have the same specific forms and the same suitable forms as j, k, R¹¹, and R¹² in formula (1).

When L^{B} is a divalent linking group, the divalent linking group is, for example, an oxygen atom, a sulfur atom, or —C(Rb¹)(Rb²)—. Rb¹ and Rb² are each independently a hydrogen atom, a C1-C10 alkyl group, a C6-C12 aryl group, or a C7-C20 aralkyl group, and Rb¹ and Rb² taken together may form a cyclic alkyl group.

The C1-C10 alkyl groups represented by Rb¹ and Rb² may be linear, branched, or cyclic. The number of carbon atoms in the alkyl groups is preferably 1 or more and 6 or less, more preferably 1 or more and 4 or less, still more preferably 1 or 2.

The C6-C12 aryl groups represented by Rb¹ and Rb² may be monocyclic or polycyclic. The number of carbon atoms in the aryl groups is preferably 6 or more and 10 or less, more preferably 6.

The alkyl group in the C7-C20 aralkyl groups represented by Rb¹ and Rb² may be linear, branched, or cyclic. The number of carbon atoms in the alkyl group in the C7-C20 aralkyl groups is preferably 1 or more and 4 or less, more preferably 1 or more and 3 or less, still more preferably 1 or 2.

The aryl group in the C7-C20 aralkyl groups represented by Rb¹ and Rb² may be monocyclic or polycyclic. The number of carbon atoms in the aryl groups is preferably 6 or more and 10 or less, more preferably 6.

The aromatic ring Ar^{B} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{B} may be substituted by alkyl groups, aryl groups, aralkyl groups, alkoxy groups, aryloxy groups, and halogen atoms. The substituents by which the aromatic ring Ar^{B} is substituted may be C1-C10 alkyl groups, C6-C12 aryl groups, and C1-C6 alkoxy groups.

The dicarboxylic acid unit (1-A) represented by formula (1-A) may be a dicarboxylic acid unit (11-A) represented by formula (11-A).

The diol unit (1-B) represented by formula (1-B) may be a diol unit (11-B) represented by formula (11-B).

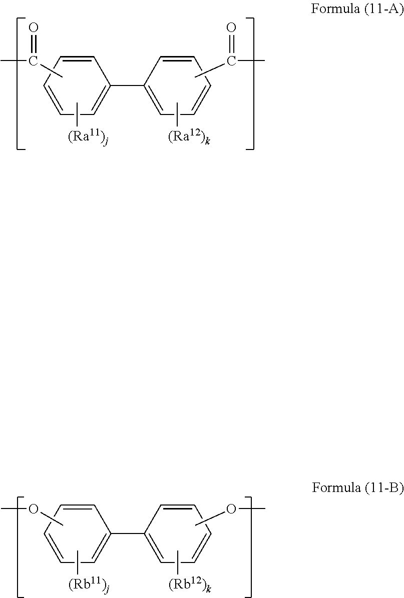

In formula (11-A), j is an integer of 0 or more and 4 or less, j R¹¹'s are each independently a methyl group or an ethyl group, k is an integer of 0 or more and 4 or less, and k R¹²'s are each independently a methyl group or an ethyl group.

In formula (11-B), j is an integer of 0 or more and 4 or less, j R^{D}'s are each independently a methyl group or an ethyl group, k is an integer of 0 or more and 4 or less, and k R¹²'s are each independently a methyl group or an ethyl group.

j, k, R¹¹, and R¹² in formula (11-A) respectively have the same definitions as j, k, R¹¹, and R¹² in formula (1) and also respectively have the same specific forms and the same suitable forms as j, k, R¹¹, and R¹² in formula (1).

j, k, R¹¹, and R¹² in formula (11-B) respectively have the same definitions as j, k, R¹¹, and R¹² in formula (1) and also respectively have the same specific forms and the same suitable forms as j, k, R¹¹, and R¹² in formula (1).

Specific examples of the dicarboxylic acid unit (1-A) include dicarboxylic acid units (1-A1) to (1-A10) describe below. The dicarboxylic acid unit (1-A) is not limited to these.

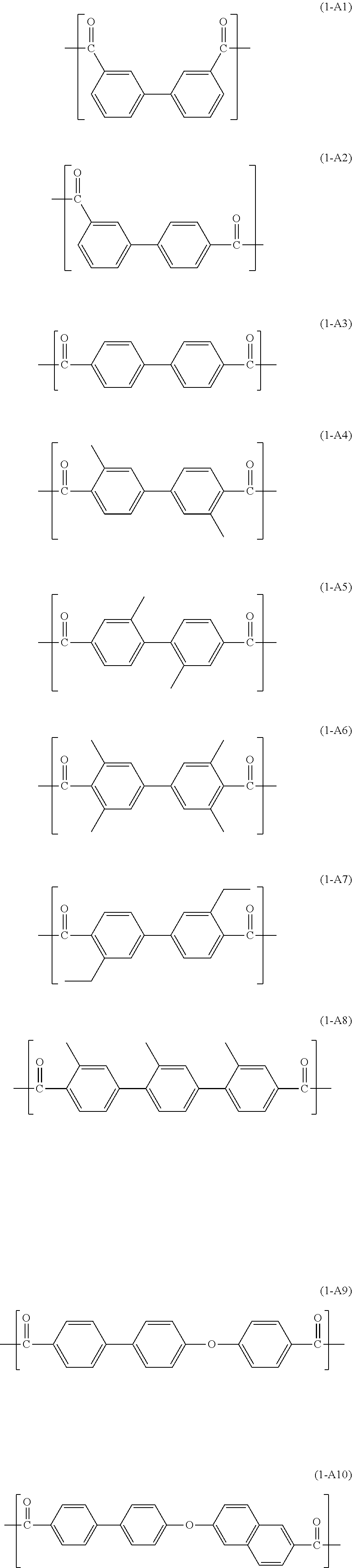

The dicarboxylic acid unit (1-A) is preferably at least one selected from the group consisting of dicarboxylic acid units (1-A3) to (1-A7), more preferably at least one selected from the group consisting of the dicarboxylic acid units (1-A3) to (1-A6), still more preferably the dicarboxylic acid unit (1-A3).

Specific examples of the diol unit (1-B) include diol units (1-B1) to (1-B10) described below. The diol unit (1-B) is not limited to these.

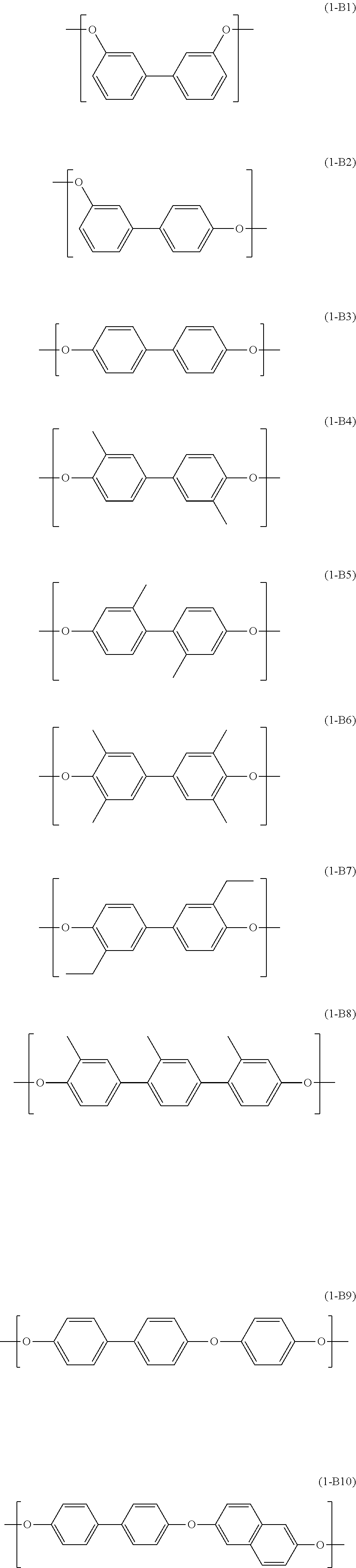

The diol unit (1-B) is preferably at least one selected from the group consisting of diol units (1-B3) to (1-B7), more preferably at least one selected from the group consisting of the diol units (1-B3) to (1-B6), still more preferably the diol unit (1-B3).

The total mass ratio of the structural unit including the biphenyl represented by formula (1) in the polyester resin (1) is preferably 15 mass % or more and 60 mass % or less, more preferably 20 mass % or more and 55 mass % or less, still more preferably 25 mass % or more and 50 mass % or less.

The polyester resin (1) may have a structural unit other than the structural unit including the biphenyl represented by formula (1). The structural unit other than the structural unit including the biphenyl represented by formula (1) will be described below.

The polyester resin (1) may include at least one dicarboxylic acid unit (A) selected from the group consisting of a dicarboxylic acid unit (A1) represented by formula (A1), a dicarboxylic acid unit (A3) represented by formula (A3), and a dicarboxylic acid unit (A4) represented by formula (A4).

When the polyester resin (1) has the dicarboxylic acid unit (A), the polyester resin (1) may have one type or two or more types of dicarboxylic acid units (A). The dicarboxylic acid unit (A) is preferably at least one selected from the group consisting of the dicarboxylic acid unit (A3) and the dicarboxylic acid unit (A4).

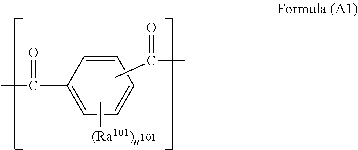

In formula (A1), n¹⁰¹ is an integer of 0 or more and 4 or less, n¹⁰¹ Ra¹¹'s are each independently a C1-C10 alkyl group, a C6-C12 aryl group, or a C1-C6 alkoxy group.

n¹⁰¹ is preferably 0, 1, or 2, more preferably 0 or 1, still more preferably 0.

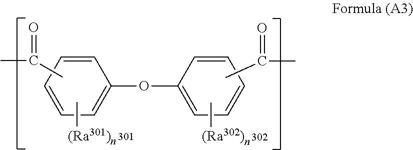

In formula (A3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group.
n³⁰¹ is preferably 0, 1, or 2, more preferably 0 or 1, still more preferably 0.
n³⁰² is preferably 0, 1, or 2, more preferably 0 or 1, still more preferably 0.

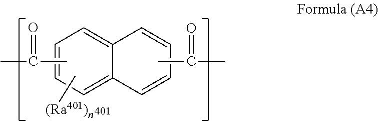

In formula (A4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.

n⁴⁰¹ is preferably an integer of 0 or more and 4 or less, more preferably 0, 1, or 2, still more preferably 0.

Since Ra¹⁰¹ in formula (A1), Ra³⁰¹ and Ra³⁰² in formula (A3), and Ra⁴⁰¹ in formula (A4) have the same specific forms and the same suitable forms, Ra¹⁰¹, Ra³⁰¹, Ra³⁰², and Ra⁴⁰¹ are collectively referred to as “Ra” in the following description.

The C1-C10 alkyl group represented by Ra may be linear, branched, or cyclic. The number of carbon atoms in the alkyl group is preferably 1 or more and 6 or less, more preferably 1 or more and 4 or less, still more preferably 1 or 2.

Examples of the C1-C10 linear alkyl group include methyl, ethyl, n-propyl, n-butyl, n-pentyl, n-hexyl, n-heptyl, n-octyl, n-nonyl, and n-decyl groups.

Examples of the C3-C10 branched alkyl group include isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

Examples of the C3-C10 cyclic alkyl group include cyclopropyl, cyclobutyl, cyclopentyl, cyclohexyl, cycloheptyl, cyclooctyl, cyclononyl, and cyclodecyl groups, and polycyclic (e.g., bicyclic, tricyclic, spirocyclic) alkyl groups where these monocyclic alkyl groups are linked to each other.

The C6-C12 aryl group represented by Ra may be monocyclic or polycyclic. The number of carbon atoms in the aryl group is preferably 6 or more and 10 or less, more preferably 6.

Examples of the C6-C12 aryl group include phenyl, biphenyl, 1-naphthyl, and 2-naphthyl groups.

The alkyl group in the C1-C6 alkoxy group represented by Ra may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Dicarboxylic acid units (A1-1) to (A1-9) are shown below as specific examples of the dicarboxylic acid unit (A1). The dicarboxylic acid unit (A1) is not limited to these.

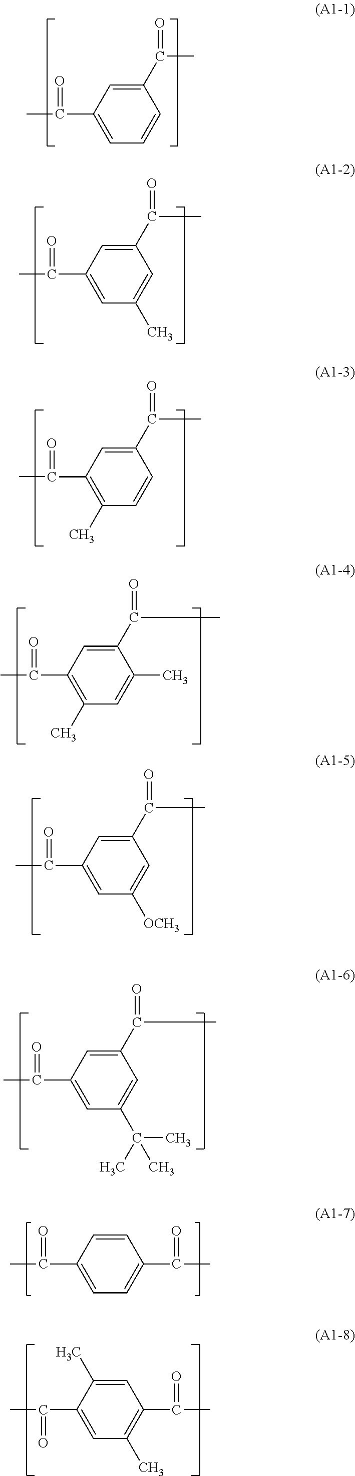

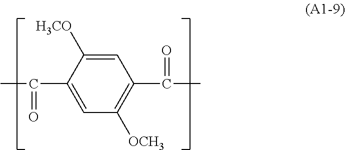

Dicarboxylic acid units (A3-1) to (A3-2) are shown below as specific examples of the dicarboxylic acid unit (A3). The dicarboxylic acid unit (A3) is not limited to these.

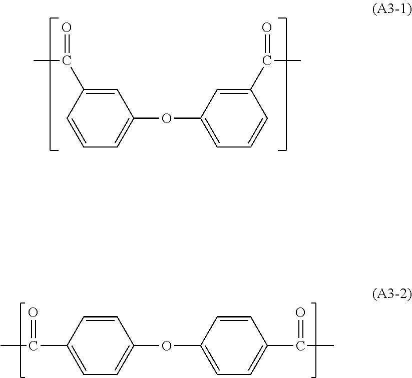

Dicarboxylic acid units (A4-1) to (A4-3) are shown below as specific examples of the dicarboxylic acid unit (A4). The dicarboxylic acid unit (A4) is not limited to these.

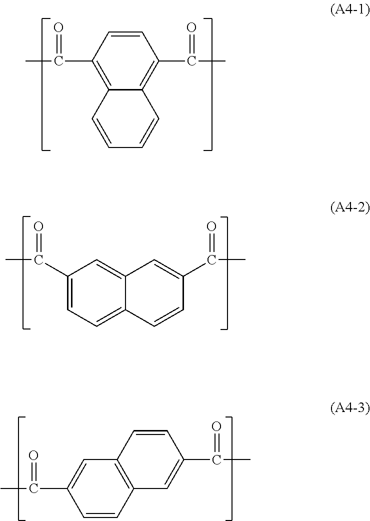

The dicarboxylic acid unit (A) preferably includes at least one selected from the group consisting of the dicarboxylic acid units (A1-1), (A1-7), (A3-2), and (A4-3) in the specific examples, more preferably includes at least one selected from the group consisting of the dicarboxylic acid units (A3-2) and (A4-3).

When the polyester resin (1) has the dicarboxylic acid unit (A), the total mass ratio of the dicarboxylic acid unit (A) in the polyester resin (1) is preferably 15 mass % or more and 60 mass % or less, more preferably 20 mass % or more and 55 mass % or less, still more preferably 25 mass % or more and 50 mass % or less.

The polyester resin (1) may have the structural unit including the biphenyl represented by formula (1) and another dicarboxylic acid unit other than the dicarboxylic acid unit (A). Examples of another dicarboxylic acid unit include aliphatic dicarboxylic acid (e.g., oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (e.g., cyclohexanedicarboxylic acid) units, and lower (e.g., C1-C5) alkyl ester units thereof. The polyester resin (1) may have one type or two or more types of these dicarboxylic acid units.

The polyester resin (1) may have at least one diol unit (B) selected from the group consisting of a diol unit (B1) represented by formula (B1), a diol unit (B2) represented by formula (B2), a diol unit (B3) represented by formula (B3), a diol unit (B4) represented by formula (B4), a diol unit (B5) represented by formula (B5), a diol unit (B6) represented by formula (B6), and a diol unit (B8) represented by formula (B8).

When the polyester resin (1) has the diol unit (B), the polyester resin (1) may have one type or two or more types of diol units (B).

The diol unit (B) is preferably at least one selected from the group consisting of the diol unit (B1), the diol unit (B2), the diol unit (B4), the diol unit (B5), and the diol unit (B6),
more preferably at least one selected from the group consisting of the diol unit (B1), the diol unit (B2), the diol unit (B5), and the diol unit (B6),
still more preferably at least one selected from the group consisting of the diol unit (B1), the diol unit (B2), and the diol unit (B6),
most preferably at least one selected from the group consisting of the diol unit (B1) and the diol unit (B2).

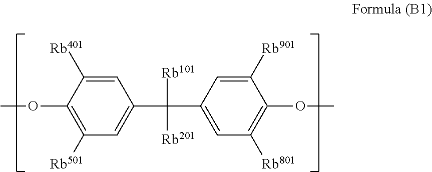

In formula (B1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom.

The number of carbon atoms in the C4-C20 branched alkyl group represented by Rb¹⁰¹ is preferably 4 or more and 16 or less, more preferably 4 or more and 12 or less, still more preferably 4 or more and 8 or less. Specific examples of Rb¹⁰¹ include isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, tert-decyl, isododecyl, sec-dodecyl, tert-dodecyl, tert-tetradecyl, and tert-pentadecyl groups.

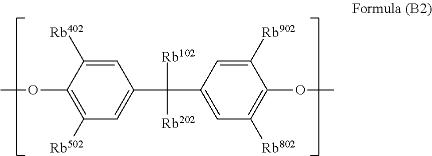

In formula (B2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom.

The number of carbon atoms in the C4-C20 linear alkyl group represented by Rb¹⁰² is preferably 4 or more and 16 or less, more preferably 4 or more and 12 or less, still more preferably 4 or more and 8 or less. Specific examples of Rb¹⁰² include n-butyl, n-pentyl, n-hexyl, n-heptyl, n-octyl, n-nonyl, n-decyl, n-undecyl, n-dodecyl, tridecyl, n-tetradecyl, n-pentadecyl, n-heptadecyl, n-octadecyl, n-nonadecyl, and n-icosyl groups.

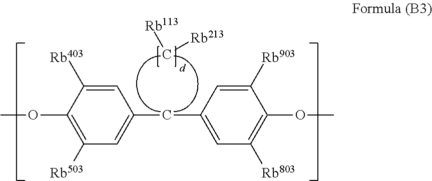

In formula (B3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴¹³, Rb⁵⁰³, Rb⁸⁰³, and Rb⁹⁰³ are each independently a hydrogen atom, a C1-C4 alkyl group, a C1-C6 alkoxy group, or a halogen atom.

The number of carbon atoms in the C1-C3 linear alkyl groups represented by Rb¹¹³ and Rb²¹³ is preferably 1 or 2, more preferably 1. Specific examples of the groups include methyl, ethyl, and n-propyl groups.

The alkyl group in the C1-C4 alkoxy groups represented by Rb¹¹³ and Rb²¹³ may be linear, branched, or cyclic. The number of carbon atoms in the alkyl group in the C1-C4 alkoxy groups is preferably 1 or more and 3 or less, more preferably 1 or 2, still more preferably 1. Specific examples of the groups include methoxy, ethoxy, n-propoxy, n-butoxy, isopropoxy, isobutoxy, sec-butoxy, tert-butoxy, cyclopropoxy, and cyclobutoxy groups.

Examples of the halogen atom represented by Rb¹¹³ and Rb²¹³ include a fluorine atom, a chlorine atom, a bromine atom, and an iodine atom.

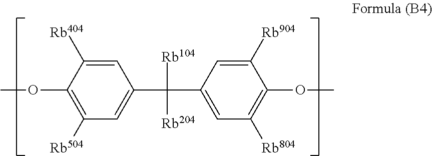

In formula (B4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom.

The C1-C3 alkyl group represented by Rb¹⁰⁴ may be linear, branched, or cyclic. The number of carbon atoms in the alkyl group is preferably 1 or 2, more preferably 1. Specific examples of Rb¹⁰⁴ include methyl, ethyl, n-propyl, isopropyl, and cyclopropyl groups.

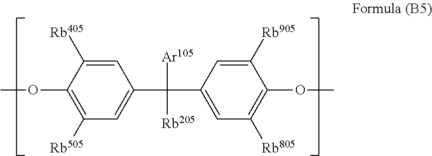

In formula (B5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom.

The C6-C12 aryl group represented by Ar¹⁰⁵ may be monocyclic or polycyclic. The number of carbon atoms in the aryl group is preferably 6 or more and 10 or less, more preferably 6.

The alkyl group in the C7-C20 aralkyl group represented by Ar¹⁰⁵ may be linear, branched, or cyclic. The number of carbon atoms in the alkyl group in the C7-C20 aralkyl group is preferably 1 or more and 4 or less, more preferably 1 or more and 3 or less, still more preferably 1 or 2. The aryl group in the C7-C20 aralkyl group represented by Ar¹⁰⁵ may be monocyclic or polycyclic. The number of carbon atoms in the aryl group is preferably 6 or more and 10 or less, more preferably 6. Examples of the C7-C20 aralkyl group include benzyl, phenylethyl, phenylpropyl, 4-phenylbutyl, phenylpentyl, phenylhexyl, phenylheptyl, phenyloctyl, phenylnonyl, naphthylmethyl, naphthylethyl, anthracenylmethyl, and phenyl-cyclopentylmethyl groups.

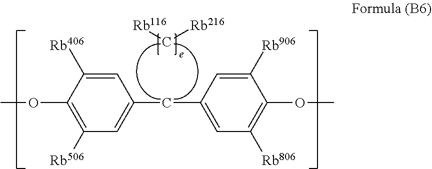

In formula (B6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom.

The number of carbon atoms in the C1-C3 linear alkyl groups represented by Rb¹¹⁶ and Rb²¹⁶ is preferably 1 or 2, more preferably 1. Specific examples of the groups include methyl, ethyl, and n-propyl groups.

The alkyl group in the C1-C4 alkoxy groups represented by Rb¹¹⁶ and Rb²¹⁶ may be linear, branched, or cyclic. The number of carbon atoms in the alkyl group in the C1-C4 alkoxy groups is preferably 1 or more and 3 or less, more preferably 1 or 2, still more preferably 1. Specific examples of the groups include methoxy, ethoxy, n-propoxy, n-butoxy, isopropoxy, isobutoxy, sec-butoxy, tert-butoxy, cyclopropoxy, and cyclobutoxy groups.

Examples of the halogen atom represented by Rb¹¹⁶ and Rb²¹⁶ include a fluorine atom, a chlorine atom, a bromine atom, and an iodine atom.

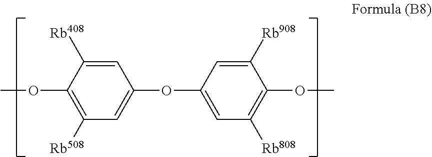

In formula (B8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.

Since Rb²⁰¹ in formula (B1), Rb²⁰² in formula (B2), Rb²⁰⁴ in formula (B4), and Rb²⁰⁵ in formula (B5) have the same specific forms and the same suitable forms, Rb²⁰¹, Rb²⁰², Rb²⁰⁴, and Rb²⁰⁵ are collectively referred to as “Rb²⁰⁰” in the following description.

The C1-C3 alkyl group represented by Rb²⁰⁰ may be linear, branched, or cyclic. The number of carbon atoms in the alkyl group is preferably 1 or 2, more preferably 1.

Examples of the C1-C3 alkyl group include methyl, ethyl, n-propyl, isopropyl, and cyclopropyl groups.

Since Rb⁴⁰¹ in formula (B1), Rb⁴⁰² in formula (B2), Rb⁴⁰³ in formula (B3), Rb⁴⁰⁴ in formula (B4), Rb⁴⁰⁵ in formula (B5), Rb⁴⁰⁶ in formula (B6), and Rb⁴⁰⁸ in formula (B8) have the same specific forms and the same suitable forms, Rb⁴⁰¹, Rb⁴⁰², Rb⁴⁰³, Rb⁴⁰⁴, Rb⁴⁰⁵, Rb⁴⁰⁶, and Rb⁴⁰⁸ are collectively referred to as “Rb⁴⁰⁰” in the following description.

The C1-C4 alkyl group represented by Rb⁴⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁴⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁴¹¹ include a fluorine atom, a chlorine atom, a bromine atom, and an iodine atom.

Since Rb⁵⁰¹ in formula (B1), Rb⁵⁰² in formula (B2), Rb⁵⁰³ in formula (B3), Rb⁵⁰⁴ in formula (B4), Rb⁵⁰⁵ in formula (B5), Rb⁵⁰⁶ in formula (B6), and Rb⁵⁰⁸ in formula (B8) have the same specific forms and the same suitable forms, Rb⁵⁰¹, Rb⁵⁰², Rb⁵⁰³, Rb⁵⁰⁴, Rb⁵⁰⁵, Rb⁵⁰⁶, and Rb⁵⁰⁸ are collectively referred to as “Rb⁵⁰⁰”, in the following description.

The C1-C4 alkyl group represented by Rb⁵⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁵⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁵⁰⁰ include a fluorine atom, a chlorine atom, a bromine atom, and an iodine atom.

Since Rb⁸⁰¹ in formula (B1), Rb⁸⁰² in formula (B2), Rb⁸⁰³ in formula (B3), Rb⁸⁰⁴ in formula (B4), Rb⁸⁰⁵ in formula (B5), Rb⁸⁰⁶ in formula (B6), and Rb⁸⁰⁸ in formula (B8) have the same specific forms and the same suitable forms, Rb⁸⁰¹, Rb⁸⁰², Rb⁸⁰³, Rb⁸⁰⁴, Rb⁸⁰⁵, Rb⁸⁰⁶, and Rb⁸⁰⁸ are collectively referred to as “Rb⁸⁰⁰” in the following description.

The C1-C4 alkyl group represented by Rb⁸⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁸⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁸⁰⁰ include a fluorine atom, a chlorine atom, a bromine atom, and an iodine atom.

Since Rb⁹⁰¹ in formula (B1), Rb⁹⁰² in formula (B2), Rb⁹⁰³ in formula (B3), Rb⁹⁰⁴ in formula (B4), Rb⁹⁰⁵ in formula (B5), Rb⁹⁰⁶ in formula (B6), and Rb⁹⁰⁸ in formula (B8) have the same specific forms and the same suitable forms, Rb⁹⁰¹, Rb⁹⁰², Rb⁹⁰³, Rb⁹⁰⁴, Rb⁹⁰⁵, Rb⁹⁰⁶, and Rb⁹⁰⁸ are collectively referred to as “Rb⁹⁰⁰” in the following description.

The C1-C4 alkyl group represented by Rb⁹⁰⁰ may be linear, branched, or cyclic. The number of carbon atoms in the alkyl group is preferably 1 or more and 3 or less, more preferably 1 or 2, still more preferably 1.

Examples of the C1-C4 linear alkyl group include methyl, ethyl, n-propyl, and n-butyl groups.

Examples of the C3-C4 branched alkyl group include isopropyl, isobutyl, sec-butyl, and tert-butyl groups.

Examples of the C3-C4 cyclic alkyl group include cyclopropyl and cyclobutyl groups.

The alkyl group in the C1-C6 alkoxy group represented by Rb⁹⁰⁰ may be linear, branched, or cyclic. The number of carbon atoms in the alkyl group in the C1-C6 alkoxy group is preferably 1 or more and 4 or less, more preferably 1 or more and 3 or less, still more preferably 1 or 2.

Examples of the C1-C6 linear alkoxy group include methoxy, ethoxy, n-propoxy, n-butoxy, n-pentyloxy, and n-hexyloxy groups.

Examples of the C3-C6 branched alkoxy group include isopropoxy, isobutoxy, sec-butoxy, tert-butoxy, isopentyloxy, neopentyloxy, tert-pentyloxy, isohexyloxy, sec-hexyloxy, and tert-hexyloxy groups.

Examples of the C3-C6 cyclic alkoxy group include cyclopropoxy, cyclobutoxy, cyclopentyloxy, and cyclohexyloxy groups.

Examples of the halogen atom represented by Rb⁹⁰⁰ include a fluorine atom, a chlorine atom, a bromine atom, and an iodine atom.

Diol units (B1-1) to (B1-6) are shown below as specific examples of the diol unit (B1). The diol unit (B1) is not limited to these.

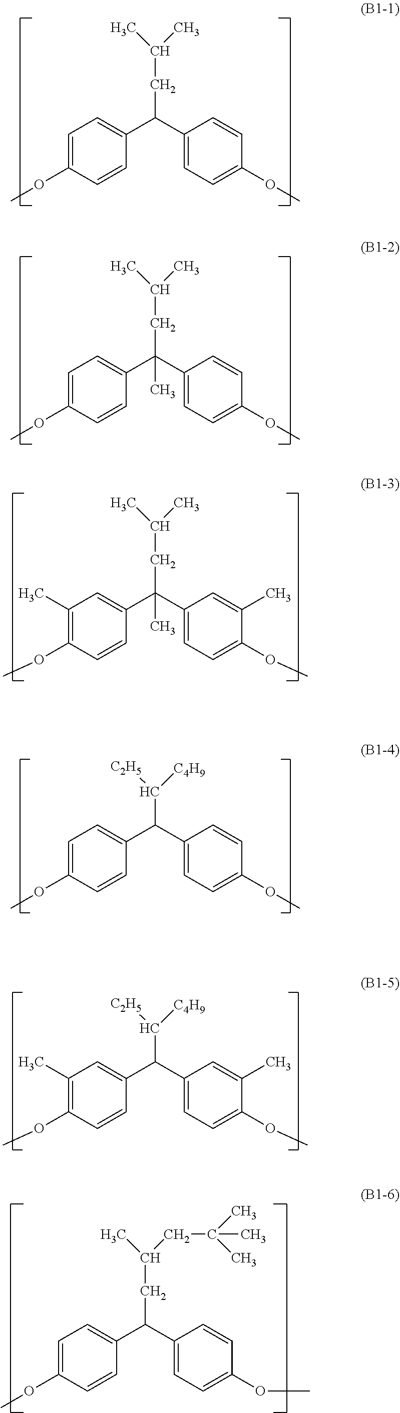

Diol units (B2-1) to (B2-11) are shown below as specific examples of the diol unit (B2). The diol unit (B2) is not limited to these.

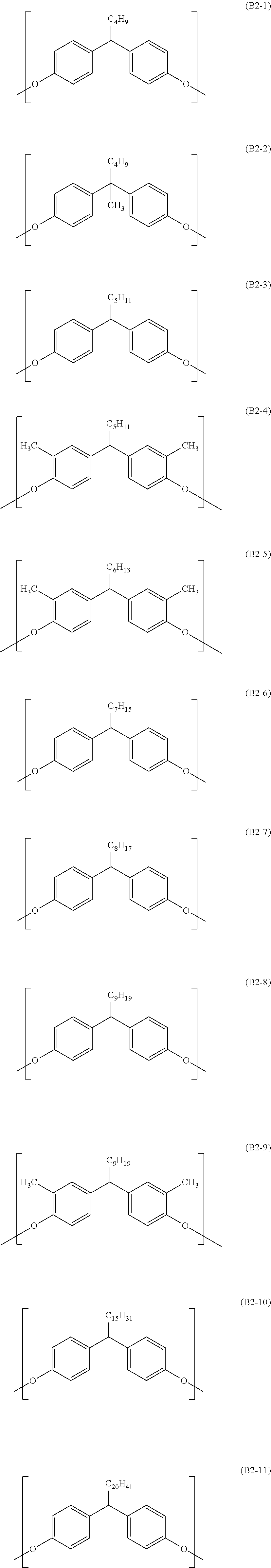

Diol units (B3-1) to (B3-4) are shown below as specific examples of the diol unit (B3). The diol unit (B3) is not limited to these.

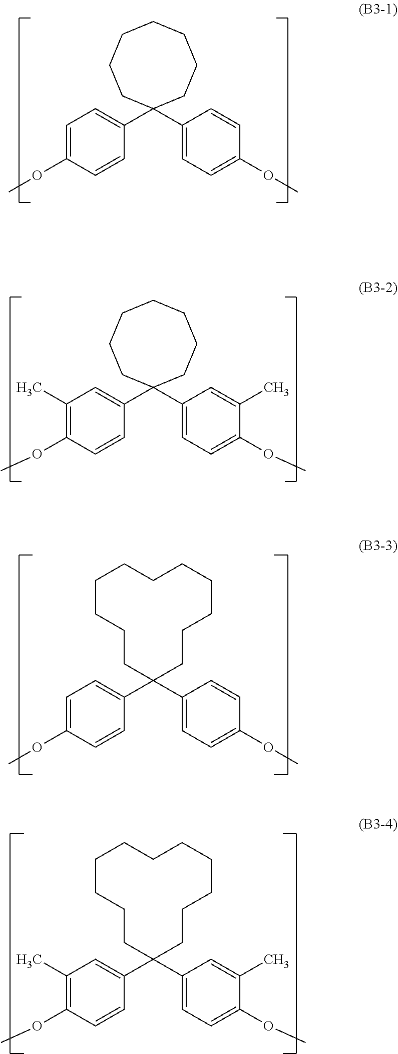

Diol units (B4-1) to (B4-7) are shown below as specific examples of the diol unit (B4). The diol unit (B4) is not limited to these.

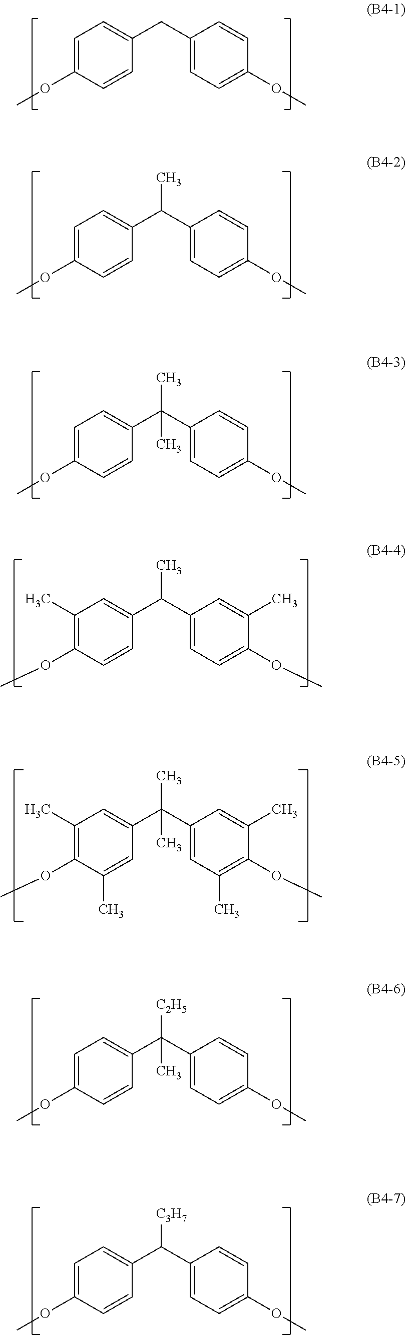

Diol units (B5-1) to (B5-6) are shown below as specific examples of the diol unit (B5). The diol unit (B5) is not limited to these.

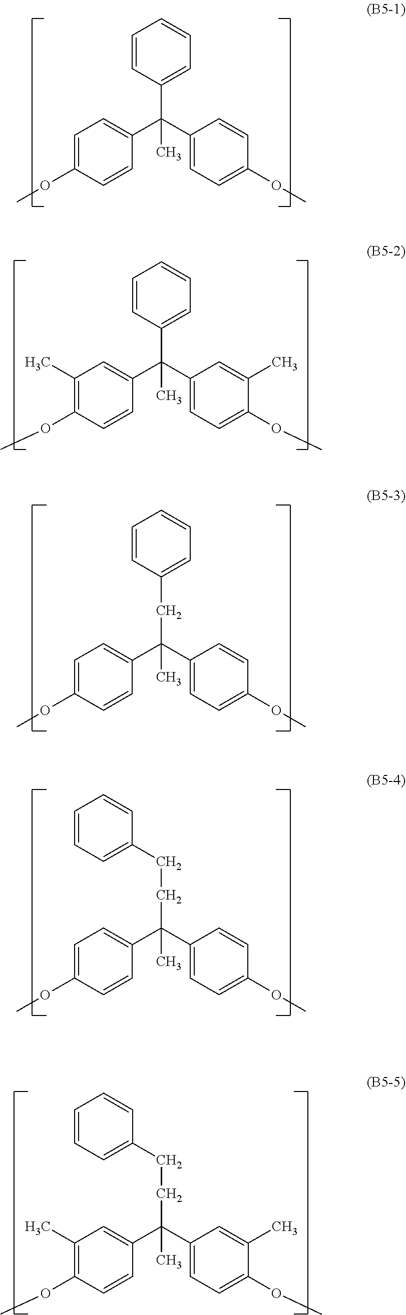

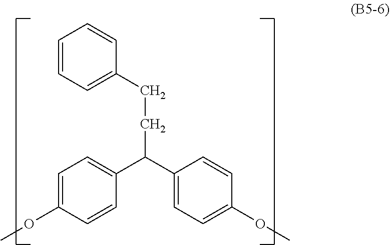

Diol units (B6-1) to (B6-4) are shown below as specific examples of the diol unit (B6). The diol unit (B6) is not limited to these.

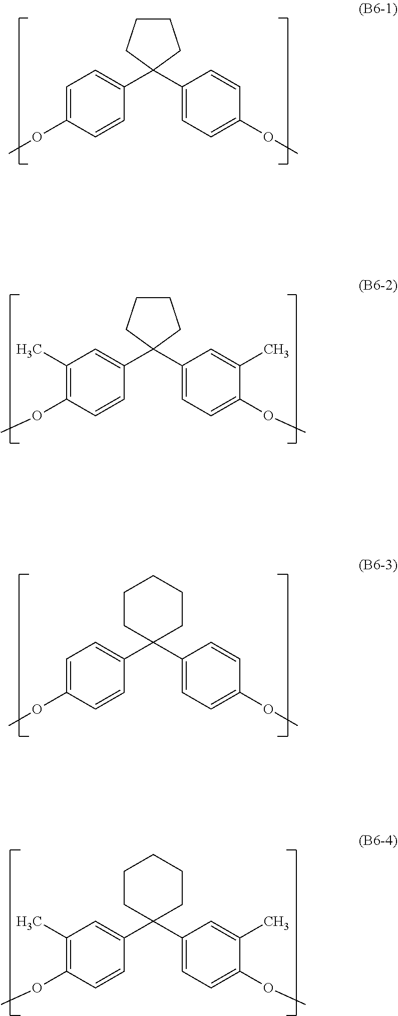

Diol units (B8-1) to (B8-3) are shown below as specific examples of the diol unit (B8). The diol unit (B8) is not limited to these.

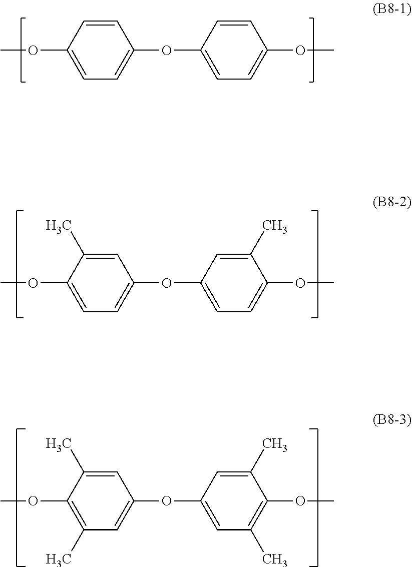

When the polyester resin (1) has the diol unit (B), the total mass ratio of the diol unit (B) in the polyester resin (1) is preferably 25 mass % or more and 80 mass % or less, more preferably 30 mass % or more and 75 mass % or less, still more preferably 35 mass % or more and 70 mass % or less.

The polyester resin (1) may have the structural unit including the biphenyl represented by formula (1) and another diol unit other than the diol unit (B). Examples of another diol unit include aliphatic diol (e.g., ethylene glycol, diethylene glycol, triethylene glycol, propylene glycol, butanediol, hexanediol, and neopentyl glycol) units, and alicyclic diol (e.g., cyclohexanediol, cyclohexanedimethanol, hydrogenated bisphenol A) units. The polyester resin (1) may include one type or two or more types of these diol units.

The terminals of the polyester resin (1) may be capped or modified with a terminal capping agent, a molecular weight regulator, or other agents used in production. Examples of the terminal capping agent or the molecular weight regulator include monohydric phenols, monovalent acid chlorides, monohydric alcohols, and monocarboxylic acids.

Examples of monohydric phenols include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, 2,6-dimethylphenol derivatives, 2-methylphenol derivatives, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of monovalent acid chlorides include monofunctional acid halides, such as benzoyl chloride, benzoic acid chloride, methanesulfonyl chloride, phenyl chloroformate, acetyl chloride, butyryl chloride, octanoyl chloride, benzenesulfonyl chloride, benzenesulfinyl chloride, sulfinyl chloride, benzenephosphonyl chloride, and substituted products thereof.

Examples of monohydric alcohols include methanol, ethanol, n-propanol, isopropanol, n-butanol, 2-butanol, pentanol, hexanol, dodecyl alcohol, stearyl alcohol, benzyl alcohol, and phenethyl alcohol.

Examples of monocarboxylic acids include acetic acid, propionic acid, octanoic acid, cyclohexanecarboxylic acid, benzoic acid, toluic acid, phenylacetic acid, p-tert-butylbenzoic acid, and p-methoxyphenylacetic acid.

The weight average molecular weight of the polyester resin (1) is preferably 30,000 or more and 300,000 or less, more preferably 40,000 or more and 250,000 or less, still more preferably 50,000 or more and 200,000 or less.

The molecular weight of the polyester resins (1) is the polystyrene-equivalent molecular weight determined by gel permeation chromatography (GPC). In GPC, tetrahydrofuran is used as an eluent.

The polyester resin (1) may be prepared by, for example, polycondensation of a monomer providing the structural unit including the biphenyl represented by formula (1), an optional monomer providing the dicarboxylic acid unit (A), an optional monomer providing the diol unit (B), and other optional monomers in accordance with a conventional method. Examples of monomer polycondensation methods include interfacial polymerization, solution polymerization, and melt polymerization. Interfacial polymerization is a polymerization method in which polyester is produced by mixing a dicarboxylic acid halide dissolved in an organic solvent incompatible with water and a dihydric alcohol dissolved in an aqueous alkaline solution. Examples of documents on interfacial polymerization include W. M. EARECKSON, J. Poly. Sci., XL399, 1959 and Japanese Examined Patent Application Publication No. 40-1959. In interfacial polymerization, the reaction proceeds more quickly than in solution polymerization, so that the dicarboxylic acid halide is less likely to undergo hydrolysis, and as a result, a polyester resin with a high molecular weight may be produced.

### Polycarbonate Resin (1)

In the present disclosure, the polycarbonate resin that has a structural unit including the biphenyl represented by formula (1) is referred to as polycarbonate resin (1).

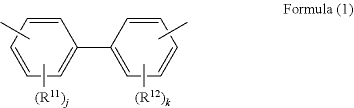

In formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

j is an integer of 0 or more and 4 or less, preferably an integer of 0 or more and 3 or less, more preferably an integer of 0 or more and 2 or less, still more preferably 0 or 1, yet still more preferably 0.

When j is an integer of 1 or more, j R¹¹'s are each independently a methyl group or an ethyl group, preferably a methyl group.

k is an integer of 0 or more and 4 or less, preferably an integer of 0 or more and 3 or less, more preferably an integer of 0 or more and 2 or less, still more preferably 0 or 1, yet still more preferably 0.

When k is an integer of 1 or more, k R¹²'s are each independently a methyl group or an ethyl group, preferably a methyl group.

To provide a structural unit including the biphenyl represented by formula (1) in molecules, the polycarbonate resin (1) may have a structural unit (1-C) represented by formula (1-C).

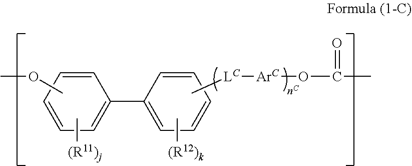

In formula (1-C), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{C} is a single bond or a divalent linking group, Ar^{C} is an optionally substituted aromatic ring, and n^{C} is 0, 1, or 2.

j, k, R¹¹, and R¹² in formula (1-C) respectively have the same definitions as j, k, R¹¹, and R¹² in formula (1) and also respectively have the same specific forms and the same suitable forms as j, k, R¹¹, and R¹² in formula (1).

When L^{C} is a divalent linking group, the divalent linking group is, for example, an oxygen atom, a sulfur atom, or —C(Rc¹)(Rc²)-. Rc¹ and Rc² are each independently a hydrogen atom, a C1-C10 alkyl group, a C6-C12 aryl group, or a C7-C20 aralkyl group, and Rc¹ and Rc² taken together may form a cyclic alkyl group.

The C1-C10 alkyl groups represented by Rc¹ and Rc² may be linear, branched, or cyclic. The number of carbon atoms in the alkyl groups is preferably 1 or more and 6 or less, more preferably 1 or more and 4 or less, still more preferably 1 or 2.

The C6-C12 aryl groups represented by Rc¹ and Rc² may be monocyclic or polycyclic. The number of carbon atoms in the aryl groups is preferably 6 or more and 10 or less, more preferably 6.

The alkyl group in the C7-C20 aralkyl groups represented by Rc¹ and Rc² may be linear, branched, or cyclic. The number of carbon atoms in the alkyl group in the C7-C20 aralkyl groups is preferably 1 or more and 4 or less, more preferably 1 or more and 3 or less, still more preferably 1 or 2.

The aryl group in the C7-C20 aralkyl groups represented by Rc¹ and Rc² may be monocyclic or polycyclic. The number of carbon atoms in the aryl groups is preferably 6 or more and 10 or less, more preferably 6.

The aromatic ring Ar^{C} may be monocyclic or polycyclic. Examples of the aromatic ring include benzene, naphthalene, anthracene, and phenanthrene rings. The aromatic ring may be a benzene ring or a naphthalene ring.

The hydrogen atoms on the aromatic ring Ar^{C} may be substituted by alkyl groups, aryl groups, aralkyl groups, alkoxy groups, aryloxy groups, and halogen atoms. The substituents by which the aromatic ring Ar^{C} is substituted may be C1-C10 alkyl groups, C6-C12 aryl groups, and C1-C6 alkoxy groups.

The structural unit (1-C) represented by formula (1-C) may be a structural unit (11-C) represented by formula (11-C).

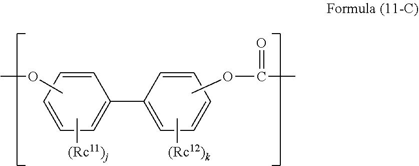

In formula (11-C), j is an integer of 0 or more and 4 or less, j R¹¹'s are each independently a methyl group or an ethyl group, k is an integer of 0 or more and 4 or less, and k R¹²'s are each independently a methyl group or an ethyl group.

j, k, R¹¹, and R¹² in formula (11-C) respectively have the same definitions as j, k, R¹¹, and R¹² in formula (1) and also respectively have the same specific forms and the same suitable forms as j, k, R¹¹, and R¹² in formula (1).

Specific examples of the structural unit (1-C) include structural units (1-C1) to (1-C10) described below. The structural unit (1-C) is not limited to these.

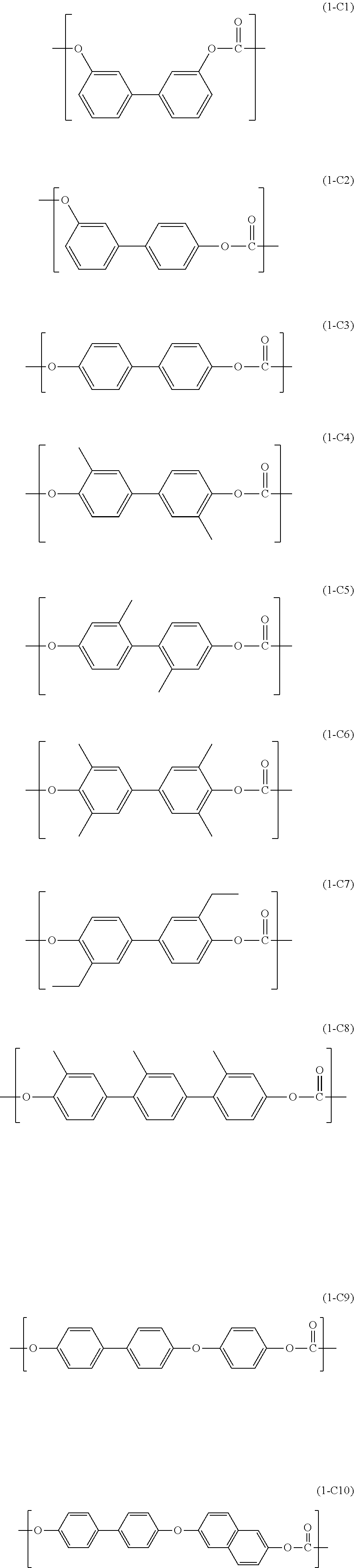

The structural unit (1-C) is preferably at least one selected from the group consisting of structural units (1-C3) to (1-C7), more preferably at least one selected from the group consisting of the structural units (1-C3) to (1-C6), still more preferably the structural unit (1-C3).

The polycarbonate resin (1) may have a structural unit other than the structural unit including the biphenyl represented by formula (11. The structural unit other than the structural unit including the biphenyl represented by formula (1) will be described below.

The polycarbonate resin (1) may have at least one structural unit (C) selected from the group consisting of a structural unit (Ca1) represented by formula (Ca1), a structural unit (Ca3) represented by formula (Ca3), a structural unit (Ca4) represented by formula (Ca4), a structural unit (Cb1) represented by formula (Cb1), a structural unit (Cb2) represented by formula (Cb2), a structural unit (Cb3) represented by formula (Cb3), a structural unit (Cb4) represented by formula (Cb4), a structural unit (Cb5) represented by formula (Cb5), a structural unit (Cb6) represented by formula (Cb6), and a structural unit (Cb8) represented by formula (Cb8).

When the polycarbonate resin (1) has the structural unit (C), the polycarbonate resin (1) may have one type or two or more types of structural units (C).

The structural unit (C) is preferably at least one selected from the group consisting of the structural unit (Cb1), the structural unit (Cb2), the structural unit (Cb3), the structural unit (Cb4), the structural unit(Cb5), the structural unit (Cb6), and the structural unit (Cb8).

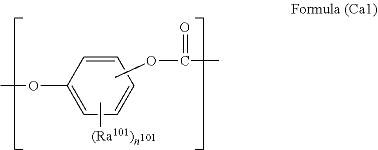

In formula (Ca1), n¹⁰¹ is an integer of 0 or more and 4 or less, n¹⁰¹ Ra¹¹'s are each independently a C1-C10 alkyl group, a C6-C12 aryl group, or a C1-C6 alkoxy group.

Ra¹⁰¹ and n¹⁰¹ in formula (Ca1) respectively have the same definitions and the same specific forms as Ra¹⁰¹ and n¹⁰¹ in formula (A1).

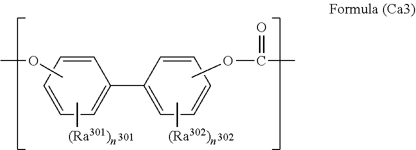

In formula (Ca3), n³⁰¹ and n³⁰² are each independently an integer of 0 or more and 4 or less, n³⁰¹ Ra³⁰¹'s and n³⁰² Ra³⁰²'s are each independently a C1-C10 alkyl group, a C6-C12 aryl group, or a C1-C6 alkoxy group.

Ra³⁰¹, Ra³⁰², n³⁰¹, and n³⁰² in formula (Ca3) respectively have the same definitions and the same specific forms as Ra³⁰¹, Ra³⁰², n³⁰¹, and n³⁰² in formula (A3).

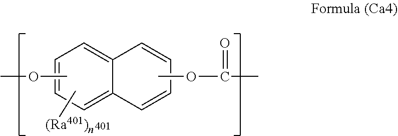

In formula (Ca4), n⁴⁰¹ is an integer of 0 or more and 6 or less, n⁴⁰¹ Ra⁴⁰¹'s are each independently a C1-C10 alkyl group, a C6-C12 aryl group, or a C1-C6 alkoxy group.

Ra⁴⁰¹ and n⁴⁰¹ in formula (Ca4) respectively have the same definitions and the same specific forms as Ra⁴⁰¹ and n⁴⁰¹ in formula (A4).

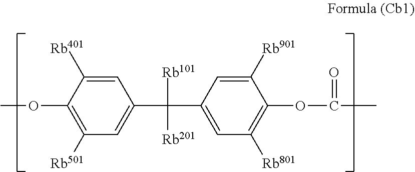

In formula (Cb1), Rb¹⁰¹ is a C4-C20 branched alkyl group, Rb²⁰¹ is a hydrogen atom or a C1-C3 alkyl group, and Rb⁴⁰¹, Rb⁵⁰¹, Rb⁸⁰¹, and Rb⁹⁰¹ are each independently a hydrogen atom, a C1-C4 alkyl group, a C1-C6 alkoxy group, or a halogen atom.

Rb¹⁰¹, Rb²⁰¹, Rb⁴⁰¹, Rb⁵⁰¹, Rb⁸⁰¹, and Rb⁹⁰¹ in formula (Cb1) respectively have the same definitions and the same specific forms as Rb⁰¹, Rb²⁰¹, Rb⁴⁰¹, Rb⁵⁰¹, Rb⁸⁰¹, and Rb⁹⁰¹ in formula (B1).

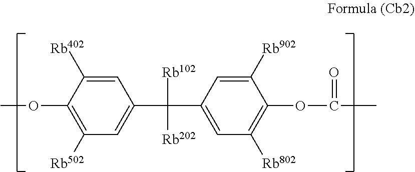

In formula (Cb2), Rb¹⁰² is a C4-C20 linear alkyl group, Rb²⁰² is a hydrogen atom or a C1-C3 alkyl group, and Rb⁴⁰², Rb⁵⁰², Rb⁸⁰², and Rb⁹⁰² are each independently a hydrogen atom, a C1-C4 alkyl group, a C1-C6 alkoxy group, or a halogen atom.

Rb¹⁰², Rb²⁰², Rb⁴⁰², Rb⁵⁰², Rb⁸⁰², and Rb⁹⁰² in formula (Cb2) respectively have the same definitions and the same specific forms as Rb¹⁰², Rb²⁰², Rb⁴⁰², Rb⁵⁰², Rb⁸⁰², and Rb⁹⁰² in formula (B2).

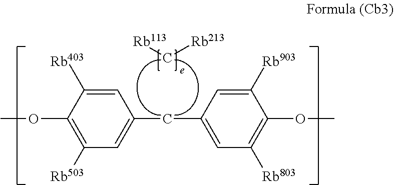

In formula (Cb3), Rb¹¹³ and Rb²¹³ are each independently a hydrogen atom, a C1-C3 linear alkyl group, a C1-C4 alkoxy group, or a halogen atom, d is an integer of 7 or more and 15 or less, and Rb⁴⁰³, Rb⁵⁰³, Rb⁸⁰³, and Rb⁹⁰³ are each independently a hydrogen atom, a C1-C4 alkyl group, a C1-C6 alkoxy group, or a halogen atom.

Rb¹¹³, Rb²¹³, d, Rb⁴⁰³, Rb⁵⁰³, Rb⁸⁰³, and Rb⁹⁰³ in formula (Cb3) respectively have the same definitions and the same specific forms as Rb¹¹³, Rb²¹³, d, Rb⁴⁰³, Rb⁵⁰³, Rb⁸⁰³, and Rb⁹⁰³ in formula (B3).

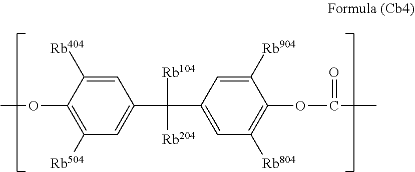

In formula (Cb4), Rb¹⁰⁴ and Rb²⁰⁴ are each independently a hydrogen atom or a C1-C3 alkyl group, and Rb⁴⁰⁴, Rb⁵⁰⁴, Rb⁸⁰⁴, and Rb⁹⁰⁴ are each independently a hydrogen atom, a C1-C4 alkyl group, a C1-C6 alkoxy group, or a halogen atom.

Rb¹⁰⁴, Rb²⁰⁴, Rb⁴⁰⁴, Rb⁵⁰⁴, Rb⁸⁰⁴, and Rb⁹⁰⁴ in formula (Cb4) respectively have the same definitions and the same specific forms as Rb¹⁰⁴, Rb²⁰⁴, Rb⁴⁰⁴, Rb⁵⁰⁴, Rb⁸⁰⁴, and Rb⁹⁰⁴ in formula (B4).

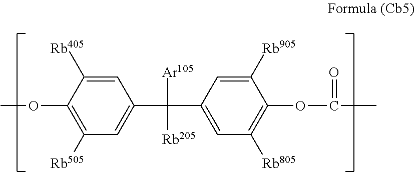

In formula (Cb5), Ar¹⁰⁵ is a C6-C12 aryl group or a C7-C20 aralkyl group, Rb²⁰⁵ is a hydrogen atom or a C1-C3 alkyl group, and Rb⁴⁰⁵, Rb⁵⁰⁵, Rb⁸⁰⁵, and Rb⁹⁰⁵ are each independently a hydrogen atom, a C1-C4 alkyl group, a C1-C6 alkoxy group, or a halogen atom.

Ar¹⁰⁵, Rb²⁰⁵, Rb⁴⁰⁵, Rb⁵⁰⁵, Rb⁸⁰⁵, and Rb⁹⁰⁵ in formula (Cb5) respectively have the same definitions and the same specific forms as Ar¹⁰⁵, Rb²⁰⁵, Rb⁴⁰⁵, Rb⁵⁰⁵, Rb⁸⁰⁵, and Rb⁹⁰⁵ in formula (B5).

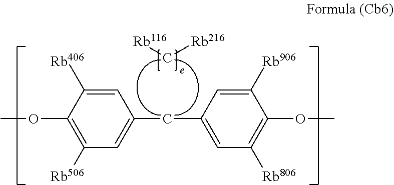

In formula (Cb6), Rb¹¹⁶ and Rb²¹⁶ are each independently a hydrogen atom, a C1-C3 linear alkyl group, a C1-C4 alkoxy group, or a halogen atom, e is an integer of 4 or more and 6 or less, and Rb⁴⁰⁶, Rb⁵⁰⁶, Rb⁸⁰⁶, and Rb⁹⁰⁶ are each independently a hydrogen atom, a C1-C4 alkyl group, a C1-C6 alkoxy group, or a halogen atom.

Rb¹¹⁶, Rb²¹⁶, e, Rb⁴⁰⁶, Rb⁵⁰⁶, Rb⁸⁰⁶, and Rb⁹⁰⁶ in formula (Cb6) respectively have the same definitions and the same specific forms as Rb¹¹⁶, Rb²¹⁶, e, Rb⁴⁰⁶, Rb⁵⁰⁶, Rb⁸⁰⁶, and Rb⁹⁰⁶ in formula (B6).

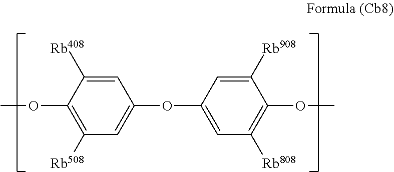

In formula (Cb8), Rb⁴⁰⁸, Rb⁵⁰⁸, Rb⁸⁰⁸, and Rb⁹⁰⁸ are each independently a hydrogen atom, a C1-C4 alkyl group, a C1-C6 alkoxy group, or a halogen atom.

Rb⁴⁰⁸, Rb⁵⁰⁸, Rb⁸⁰⁸, and Rb⁹⁰⁸ in formula (Cb8) respectively have the same definitions and the same specific forms as Rb⁴⁰⁸, Rb⁵⁰⁸, Rb⁸⁰⁸, and Rb⁹⁰⁸ in formula (B8).

Structural units (Ca1-1) to (Ca1-9) are shown below as specific examples of the structural unit (Ca1). The structural unit (Ca1) is not limited to these.

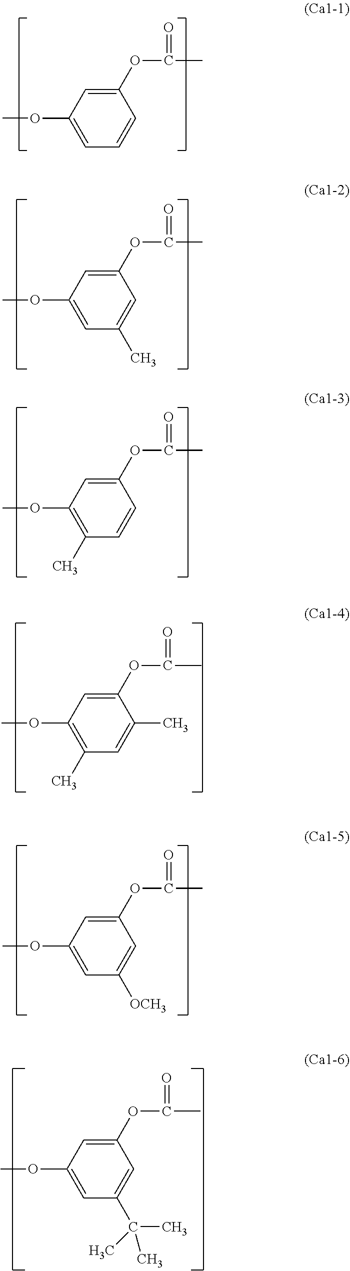

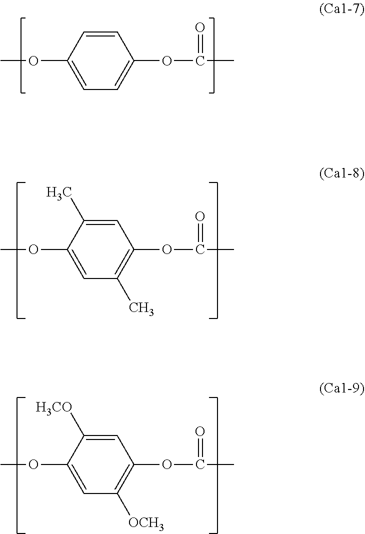

Structural units (Ca3-1) to (Ca3-2) are shown below as specific examples of the structural unit (Ca3). The structural unit (Ca3) is not limited to these.

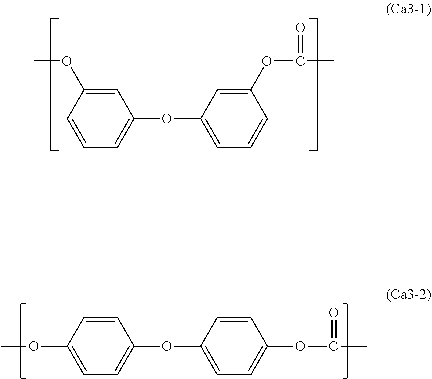

Structural units (Ca4-1) to (Ca4-3) are shown below as specific examples of the structural unit (Ca4). The structural unit (Ca4) is not limited to these.

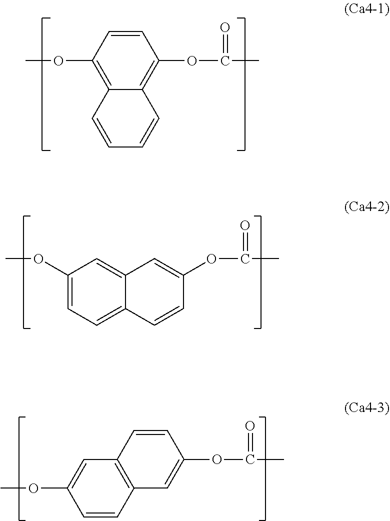

Structural units (Cb1-1) to (Cb1-6) are shown below as specific examples of the structural unit (Cb1). The structural unit (Cb1) is not limited to these.

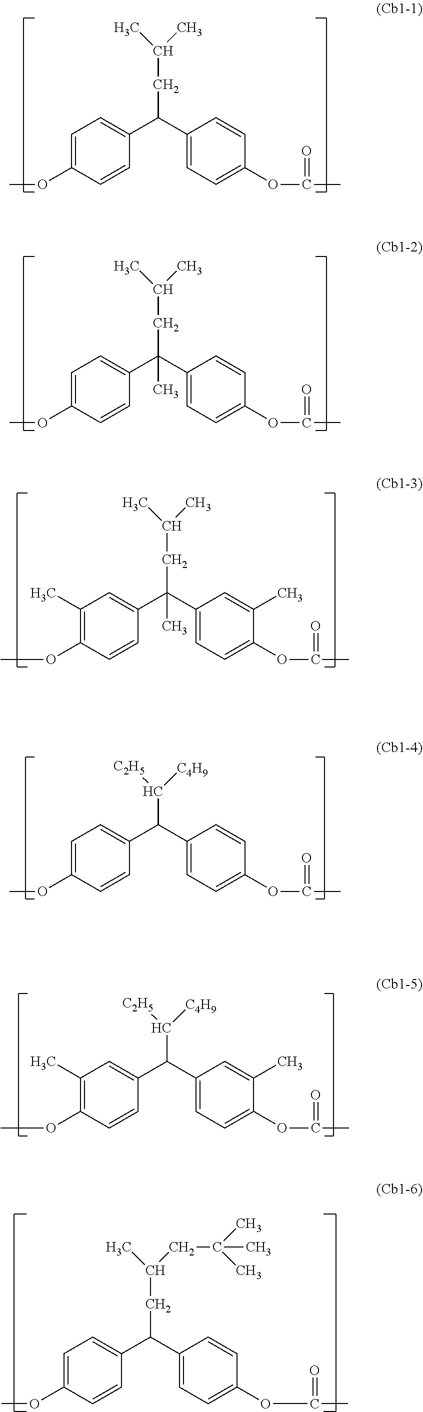

Structural units (Cb2-1) to (Cb2-11) are shown below as specific examples of the structural unit (Cb2). The structural unit (Cb2) is not limited to these.

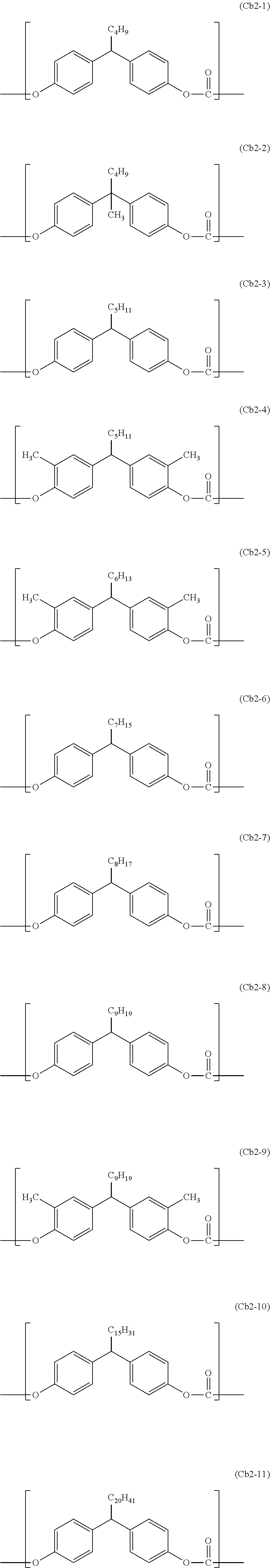

Structural units (Cb3-1) to (Cb3-4) are shown below as specific examples of the structural unit (Cb3). The structural unit (Cb3) is not limited to these.

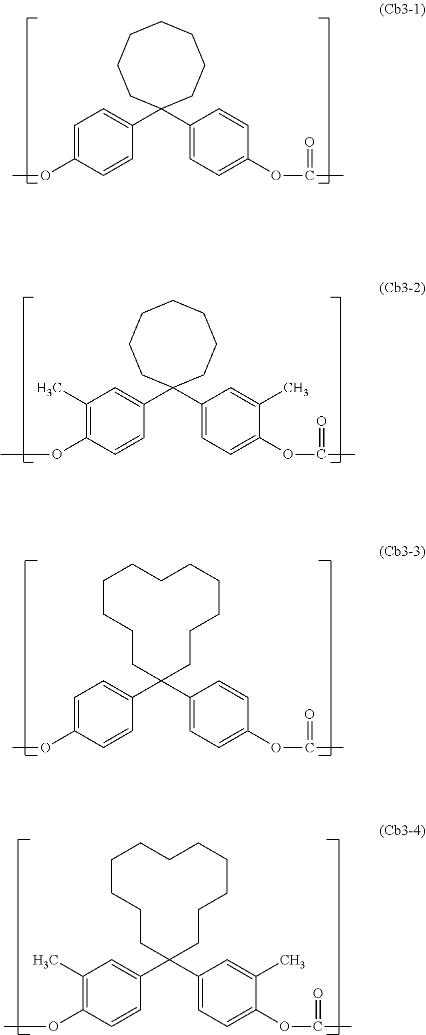

Structural units (Cb4-1) to (Cb4-7) are shown below as specific examples of the structural unit (Cb4). The structural unit (Cb4) is not limited to these.

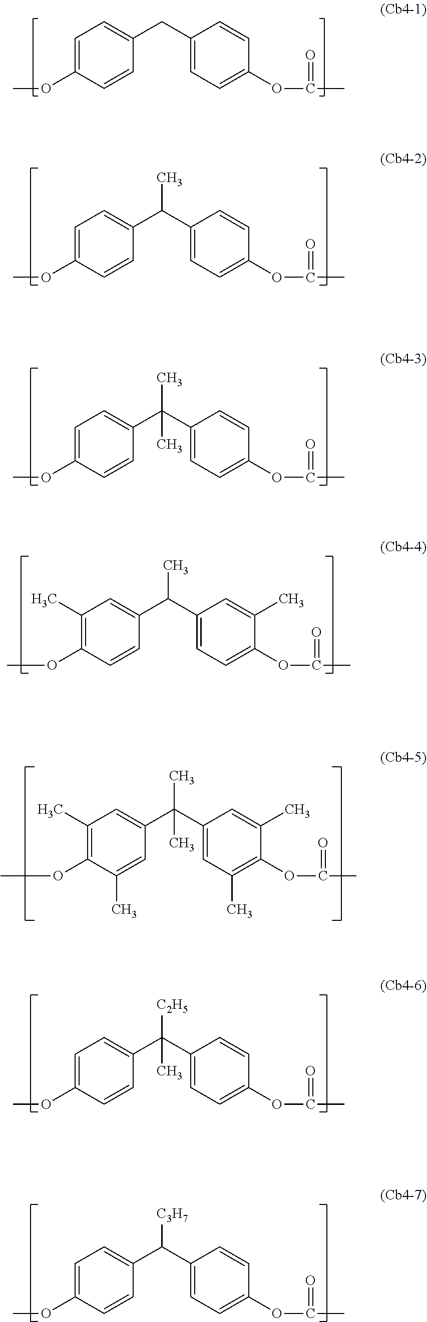

Structural units (Cb5-1) to (Cb5-6) are shown below as specific examples of the structural unit (Cb5). The structural unit (Cb5) is not limited to these.

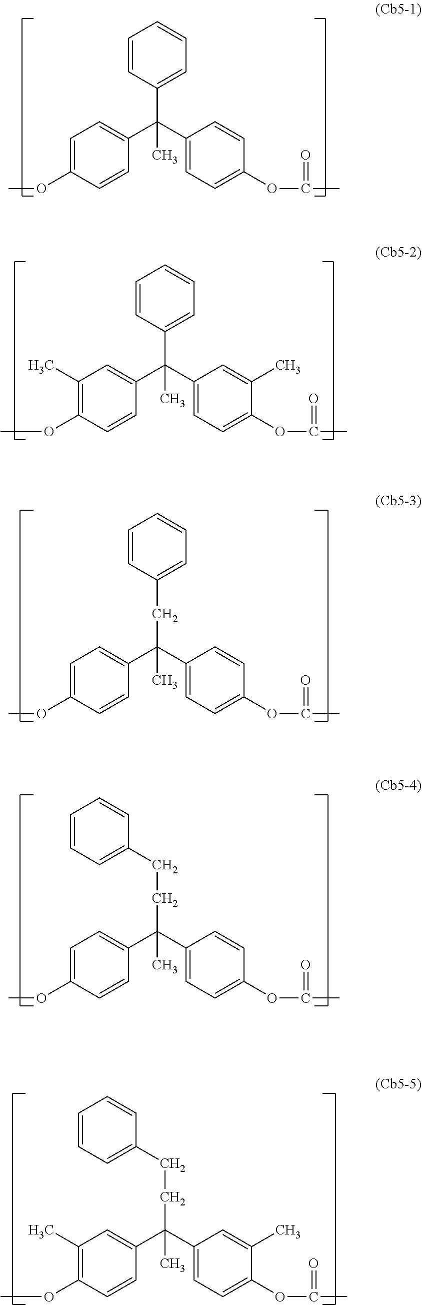

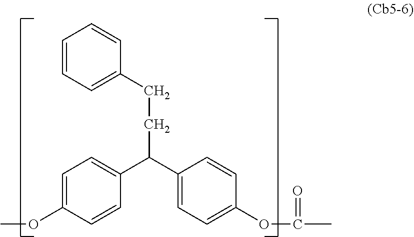

Structural units (Cb6-1) to (Cb6-4) are shown below as specific examples of the structural unit (Cb6). The structural unit (Cb6) is not limited to these.

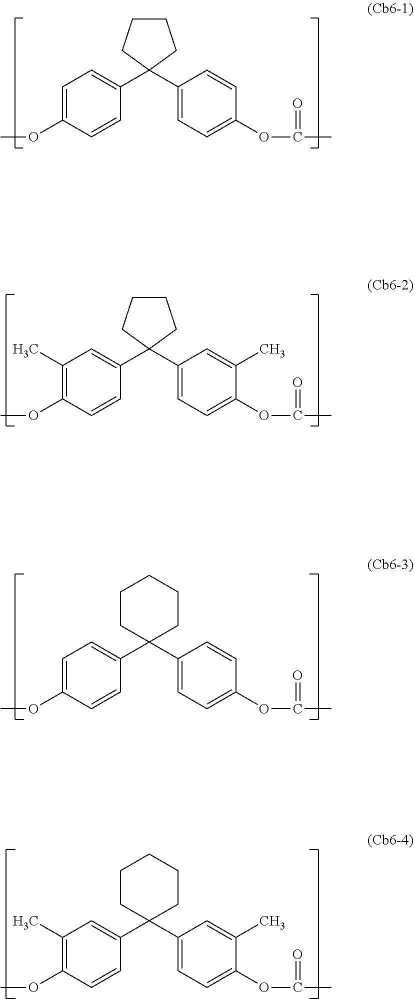

Structural units (Cb8-1) to (Cb8-3) are shown below as specific examples of the structural unit (Cb8). The structural unit (Cb8) is not limited to these.

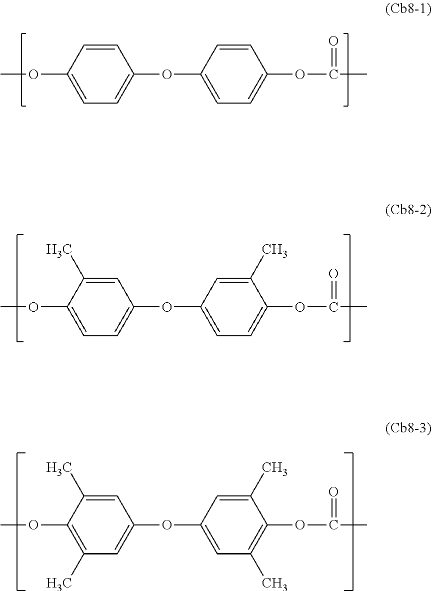

When the polycarbonate resin (1) has the structural unit (C), the mass ratio of the structural unit (C) in the polycarbonate resin (1) is preferably 20 mass % or more and 70 mass % or less, more preferably 30 mass % or more and 60 mass % or less, still more preferably 40 mass % or more and 50 mass % or less.

The polycarbonate resin (1) may have the structural unit including the biphenyl represented by formula (1) and another structural unit other than the structural unit (C). Examples of another structural unit include structural units derived from aliphatic diols (e.g., ethylene glycol, diethylene glycol, triethylene glycol, propylene glycol, butanediol, hexanediol, and neopentyl glycol) and phosgene, and structural units derived from alicyclic diols (e.g., cyclohexanediol, cyclohexanedimethanol, hydrogenated bisphenol A) and phosgene. The polycarbonate resin (1) may include one type or two or more types of these structural unit.

The terminals of the polycarbonate resin (1) may be capped or modified with a terminal capping agent, a molecular weight regulator, or other agents used to produce the resin. The terminal capping agent or the molecular weight regulator may be any of the terminal capping agents or the molecular weight regulators described above for the polyester resin (1).

The weight average molecular weight of the polycarbonate resin (1) is preferably 35,000 or more and 300,000 or less, more preferably 40,000 or more and 250,000 or less, still more preferably 50,000 or more and 200,000 or less.

The molecular weight of the polycarbonate resin (1) is the polystyrene-equivalent molecular weight determined by gel permeation chromatography (GPC). GPC is performed by using, for example, tetrahydrofuran or chloroform as an eluent in accordance with a conventional method.

Examples of the method for producing the polycarbonate resin (1) include known polymerization methods (interfacial polymerization, solution polymerization, and melt polymerization). Specific examples of the polymerization reaction include a polymerization reaction involving the reaction of a diol with a carbonate precursor, such as phosgene or carbonate diester. The structural unit of the polycarbonate resin (1) can be introduced into the polycarbonate resin by using, for example, a diol providing the structural unit in polymerization.

Each layer of the photoreceptor will be described below in detail.

### Conductive Substrate

Examples of the conductive substrate include metal plates, metal drums, and metal belts containing metals (e.g., aluminum, copper, zinc, chromium, nickel, molybdenum, vanadium, indium, gold, and platinum) or alloys (e.g., stainless steel). Examples of the conductive substrate also include conductive compound (e.g., conductive polymer, indium oxide), metal (e.g., aluminum, palladium, gold), or alloy-coated, -vapor-deposited, or -laminated paper, resin films, and belts. The term “conductive” means that the volume resistivity is less than 1×10¹³ Ω·cm.

The surface of the conductive substrate may be roughened into a center-line average roughness Ra of 0.04 μm or more and 0.5 μm or less in order to prevent or reduce interference fringes generated by irradiation with laser light when the electrophotographic photoreceptor is used in a laser printer. When incoherent light is used as a light source, surface roughening for preventing interference fringes is not required but suitable for longer life since it prevents generation of defects otherwise caused by surface unevenness of the conductive substrate.

Examples of the surface roughening method include: wet honing in which a suspension of an abrasive in water is sprayed onto the conductive substrate; centerless grinding in which the conductive substrate is continuously ground while being pressed against a rotating grindstone; and an anodizing treatment.

Examples of the surface roughening method also include a method in which a dispersion of a conductive or semiconductive powder in a resin is applied to the surface of a conductive substrate without roughing the surface of the conductive substrate to form a layer on the surface of the conductive substrate so that the particles dispersed in the layer form a rough surface.

The surface roughing treatment by anodization involves anodizing a metal (e.g., aluminum) conductive substrate, which is used as an anode, in an electrolyte solution to form an oxide film on the surface of the conductive substrate. Examples of the electrolyte solution include a sulfuric acid solution and an oxalic acid solution. However, a porous anodized film formed by anodization is chemically active, easily contaminated, and greatly varies in resistance depending on the environment as it is. For this, the porous anodized film may be subjected to pore-sealing in which the fine pores of the anodized film are sealed by volume expansion caused by the hydration reaction in pressurized steam or boiling water (may contain a metal salt, such as a nickel salt), resulting in a more stable hydrated oxide.

The anodized film may have a film thickness of, for example, 0.3 μm or more and 15 μm or less. When the film thickness is in the above range, the anodized film tends to function as a barrier against injection and tends to prevent or reduce an increase in residual potential caused by repeated use.

The conductive substrate may be subjected to the treatment with an acid treatment liquid or the boehmite treatment.

The treatment with an acid treatment liquid is carried out, for example, as described below. First, an acid treatment liquid containing phosphoric acid, chromic acid, and hydrofluoric acid is prepared. With regard to the mixing ratios of phosphoric acid, chromic acid, and hydrofluoric acid in the acid treatment liquid, the acid treatment liquid contains, for example, phosphoric acid in the range of 10 mass % or more and 11 mass % or less, chromic acid in the range of 3 mass % or more and 5 mass % or less, and hydrofluoric acid in the range of 0.5 mass % or more and 2 mass % or less. The total concentration of these acids may be in the range of 13.5 mass % or more and 18 mass % or less. The treatment temperature may be, for example, 42° C. or higher and 48° C. or lower. The coating film may have a film thickness of, for example, 0.3 μm or more and 15 μm or less.

The boehmite treatment involves, for example, dipping the conductive substrate in pure water of 90° C. or higher and 100° C. or lower for 5 minutes to 60 minutes or bringing the conductive substrate into contact with hot steam of 90° C. or higher and 120° C. or lower for 5 minutes to 60 minutes. The coating film may have a film thickness of, for example, 0.1 μm or more and 5 μm or less. The conductive substrate may be further anodized by using an electrolyte solution in which the coating film is less soluble, such as adipic acid, boric acid, a borate salt, a phosphate salt, a phthalate salt, a maleate salt, a benzoate salt, a tartrate salt, or a citrate salt.

### Undercoat Layer

The undercoat layer is, for example, a layer containing inorganic particles and a binder resin.

Examples of the inorganic particles include inorganic particles having a powder resistance (volume resistivity) of 1×10² Ω·cm or more and 1×10¹¹ Ω·cm or less.

In particular, the inorganic particles having the above resistance value are, for example, preferably metal oxide particles, such as tin oxide particles, titanium oxide particles, zinc oxide particles, or zirconium oxide particles, more preferably zinc oxide particles.

The inorganic particles may have a BET specific surface area of, for example, 10 m²/g or more.

The inorganic particles may have a volume average particle size of, for example, 50 nm or more and 2000 nm or less (e.g., 60 nm or more and 1000 nm or less).

The amount of the inorganic particles relative to the binder resin is, for example, preferably 10 mass % or more and 80 mass % or less, more preferably 40 mass % or more and 80 mass % or less.

The inorganic particles may be surface-treated. The inorganic particles may be a mixture of two or more types of differently surface-treated inorganic particles or two or more types of inorganic particles having different particle sizes.

Examples of the surface treatment agent include silane coupling agents, titanate coupling agents, aluminum coupling agents, and surfactants. In particular, silane coupling agents are preferred, and silane coupling agents having amino groups are more preferred.

Examples of silane coupling agents having amino groups include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

The silane coupling agents may be used as a mixture of two or more. For example, a silane coupling agent having an amino group and another silane coupling agent may be used in combination. Examples of another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using a surface treatment agent may be any of known methods and may be a dry method or a wet method.

The amount of the surface treatment agent used may be, for example, 0.5 mass % or more and 10 mass % or less relative to the inorganic particles.

The undercoat layer may contain an electron-accepting compound (acceptor compound) as well as the inorganic particles because this composition improves the long-term stability of electrical properties and the carrier blocking properties.

Examples of the electron-accepting compound include electron-transporting substances, such as quinone compounds, such as chloranil and bromoanil; tetracyanoquinodimethane compounds; fluorenone compounds, such as 2,4,7-trinitrofluorenone and 2,4,5,7-tetranitro-9-fluorenone; oxadiazole compounds, such as 2-(4-biphenyl)-5-(4-t-butylphenyl)-1,3,4-oxadiazole, 2,5-bis(4-naphthyl)-1,3,4-oxadiazole, 2,5-bis(4-diethylaminophenyl)-1,3,4-oxadiazole; xanthone compounds; thiophene compounds; diphenoquinone compounds, such as 3,3′,5,5′-tetra-t-butyldiphenoquinone; and benzophenone compounds, such as 4-hydroxybenzophenone and 2,3,4-trihydroxybenzophenone.

In particular, the electron-accepting compound may be a compound having an anthraquinone structure. Examples of the compound having an anthraquinone structure include hydroxyanthraquinone compounds, aminoanthraquinone compounds, and aminohydroxyanthraquinone compounds. Specific examples include anthraquinone, alizarin, quinizarin, anthralphine, and purpurin.

The electron-accepting compound may be dispersed together with the inorganic particles in the undercoat layer, or may be attached to the surfaces of the inorganic particles in the undercoat layer.

Examples of the method for attaching the electron-accepting compound to the surfaces of the inorganic particles include dry methods and wet methods.

An example of dry methods involves, while stirring the inorganic particles in, for example, a mixer with a large shear force, adding an electron-accepting compound dropwise directly or in the form of a solution in an organic solvent or spraying the electron-accepting compound together with dry air or nitrogen gas so that the electron-accepting compound is attached to the surfaces of the inorganic particles. The electron-accepting compound is added dropwise or sprayed at a temperature lower than or equal to the boiling point of the solvent. After the electron-accepting compound is added dropwise or sprayed, baking at 100° C. or higher may further be performed. The temperature and time of baking are not limited as long as the electrophotographic properties are obtained.

An example of wet methods involves, while dispersing the inorganic particles in a solvent by stirring or by using ultrasonic waves, a sand mill, an attritor, or a ball mill, or other means, adding an electron-accepting compound, stirring or dispersing it, and then removing the solvent so that the electron-accepting compound is attached to the surfaces of the inorganic particles. The solvent removal method involves, for example, filtering or evaporating the solvent off. After solvent removal, baking at 100° C. or higher may further be performed. The temperature and time of baking are not limited as long as the electrophotographic properties are obtained. In a wet method, water contained in the inorganic particles may be removed before adding the electron-accepting compound. For example, water may be removed by heating under stirring in the solvent, or water may be removed by boiling together with the solvent.

The attachment of the electron-accepting compound may be performed before or after the inorganic particles are surface-treated with a surface treatment agent, or the attachment of the electron-accepting compound and the surface treatment with a surface treatment agent may be performed at the same time.

The amount of the electron-accepting compound relative to the inorganic particles is, for example, 0.01 mass % or more and 20 mass % or less, preferably 0.01 mass % or more and 10 mass % or less.

Examples of the binder resin used in the undercoat layer include known polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Examples of the binder resin used in the undercoat layer also include charge-transporting resins having charge-transporting groups, and conductive resins (e.g., polyaniline).

In particular, the binder resin used in the undercoat layer is preferably a resin insoluble in the coating solvent for the overlying layer, more preferably a resin produced by the reaction between a curing agent and at least one resin selected from the group consisting of thermosetting resins, such as urea resins, phenol resins, phenol-formaldehyde resins, melamine resins, urethane resins, unsaturated polyester resins, alkyd resins, and epoxy resins; polyamide resins, polyester resins, polyether resins, methacrylic resins, acrylic resins, polyvinyl alcohol resins, and polyvinyl acetal resins.

When two or more of these binder resins are used in combination, the mixing ratio of the binder resins is set as needed.

The undercoat layer may contain various additives to improve electrical properties, environmental stability, and image quality.

Examples of the additives include known materials, such as polycyclic condensation-type and azo-type electron-transporting pigments, zirconium chelate compounds, titanium chelate compounds, aluminum chelate compounds, titanium alkoxide compounds, organic titanium compounds, and silane coupling agents. The silane coupling agent is used in the surface treatment of the inorganic particles as described above, but may further be added to the undercoat layer as an additive.

Examples of the silane coupling agent used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of zirconium chelate compounds include zirconium butoxide, ethyl zirconium acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octoate, zirconium naphthenate, zirconium laurate, zirconium stearate, zirconium isostearate, methacrylate zirconium butoxide, stearate zirconium butoxide, and isostearate zirconium butoxide.

Examples of titanium chelate compounds include tetraisopropyl titanate, tetra-n-butyl titanate, butyl titanate dimer, tetra(2-ethylhexyl)titanate, titanium acetylacetonate, polytitanium acetylacetonate, titanium octylene glycolate, titanium lactate ammonium salt, titanium lactate, titanium lactate ethyl ester, titanium triethanolaminate, and polyhydroxytitanium stearate.

Examples of the aluminum chelate compounds include aluminum isopropylate, monobutoxyaluminum diisopropylate, aluminum butyrate, diethyl acetoacetate aluminum diisopropylate, and aluminum tris(ethylacetoacetate).

These additives may be used singly or used as a mixture or polycondensate of two or more compounds.

The undercoat layer may have a Vickers hardness of 35 or more.

To prevent or reduce moire fringes, the surface roughness (ten-point average roughness) of the undercoat layer may be adjusted in the range of from 1/(4n) (n represents the refractive index of the overlying layer) to ½ of the laser wavelength λ for exposure.

To adjust the surface roughness, the undercoat layer may contain resin particles and the like. Examples of the resin particles include silicone resin particles and cross-linked polymethyl methacrylate resin particles. The surface of the undercoat layer may be polished to adjust the surface roughness. Examples of the polishing method include buff polishing, sand blasting, wet honing, and grinding.

The undercoat layer may be formed by any of known forming methods. For example, a coating liquid for forming the undercoat layer is prepared by adding the above components to a solvent, and a coating film of the coating liquid is formed, dried, and heated as needed.

Examples of the solvent used for preparing the coating liquid for forming the undercoat layer include known organic solvents, such as alcohol solvents, aromatic hydrocarbon solvents, halogenated hydrocarbon solvents, ketone solvents, ketone-alcohol solvents, ether solvents, and ester solvents.

Specific examples of these solvents include common organic solvents, such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing the inorganic particles to prepare the coating liquid for forming the undercoat layer include known methods using a roll mill, a ball mill, a vibrating ball mill, an attritor, a sand mill, a colloid mill, a paint shaker, or the like.

Examples of the method for applying the coating liquid for forming the undercoat layer onto the conductive substrate include common methods, such as a blade coating method, a wire bar coating method, a spray coating method, a dip coating method, a bead coating method, an air knife coating method, and a curtain coating method.

The average thickness of the undercoat layer is preferably set to, for example, 15 μm or more, more preferably in the range of 20 μm or more and 50 μm or less.

### Intermediate Layer

An intermediate layer may be further disposed between the undercoat layer and the photosensitive layer.

The intermediate layer is, for example, a layer containing a resin. Examples of the resin used in the intermediate layer include polymer compounds, such as acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer containing an organometallic compound. Examples of the organometallic compound used in the intermediate layer include organometallic compounds containing a metal atom, such as zirconium, titanium, aluminum, manganese, or silicon.

These compounds used in the intermediate layer may be used singly or used as a mixture or polycondensate of two or more compounds.

In particular, the intermediate layer may be a layer containing an organometallic compound containing a zirconium atom or a silicon atom.

The intermediate layer may be formed by any of known forming methods. For example, a coating liquid for forming the intermediate layer is prepared by adding the above components to a solvent, and a coating film of the coating liquid is formed, dried, and heated as needed.

Examples of the coating method for forming the intermediate layer include common methods, such as a dip coating method, a lift coating method, a wire bar coating method, a spray coating method, a blade coating method, an air knife coating method, and a curtain coating method.

The thickness of the intermediate layer may be set, for example, in the range of 0.1 μm or more and 3 μm or less. The intermediate layer may be used as the undercoat layer.

### Charge Generation Layer

The charge generation layer is, for example, a layer containing a charge-generating material and a binder resin. The charge generation layer may be a layer formed by vapor deposition of the charge-generating material. The layer formed by vapor deposition of a charge-generating material is suitable for the case of using an incoherent light source, such as a light emitting diode (LED) or an organic electro-luminescence (EL) image array.

Examples of the charge-generating material include azo pigments, such as bisazo and trisazo pigments; fused-ring aromatic pigments, such as dibromoanthanthrone; perylene pigments; pyrrolopyrrole pigments; phthalocyanine pigments; zinc oxide; and trigonal selenium.

For laser exposure in the near-infrared region, the charge-generating material is preferably a metal phthalocyanine pigment or a metal-free phthalocyanine pigment. Specifically, for example, hydroxygallium phthalocyanine, chlorogallium phthalocyanine, dichlorotin phthalocyanine, and titanyl phthalocyanine are more preferred.

For laser exposure in the near-ultraviolet region, the charge-generating material is preferably, for example, a fused-ring aromatic pigment, such as dibromoanthanthrone; a thioindigo pigment; a porphyrazine compound; zinc oxide; trigonal selenium; or a bisazo pigment.

In the case of using an incoherent light source, such as an LED or organic EL image array having an emission center wavelength of 450 nm or more and 780 nm or less, the charge-generating material described above may also be used.

When an n-type semiconductor, such as a fused-ring aromatic pigment, a perylene pigment, or an azo pigment, is used as the charge-generating material, a dark current is difficult to generate, and image defects called black spots may be prevented or reduced even in a thin film. Whether the material is of n-type or not is determined by using a common time-of-flight method on the basis of the polarity of a flowing photocurrent, and a material that allows electrons to flow more easily as carriers than holes is determined to be of n-type.

The binder resin used in the charge generation layer is selected from a wide range of insulating resins, and may be selected from organic photoconductive polymers, such as poly-N-vinylcarbazole, polyvinyl anthracene, polyvinyl pyrene, and polysilane.

Examples of the binder resin include polyvinyl butyral resins, polyarylate resins (e.g., polycondensates of bisphenols and divalent aromatic carboxylic acids), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinylpyrrolidone resins. The term “insulating” as used herein means that the volume resistivity is 1×10¹³ Ω·cm or more.

These binder resins are used singly or as a mixture of two or more.

The blending ratio of the charge-generating material to the binder resin may be in the range of from 10:1 to 1:10 in terms of mass ratio.

The charge generation layer may contain other known additives.

The charge generation layer may be formed by any of known forming methods. For example, a coating liquid for forming the charge generation layer is prepared by adding the above components to a solvent, and a coating film of the coating liquid is formed, dried, and heated as needed. The charge generation layer may be formed by vapor deposition of the charge-generating material. The formation of the charge generation layer by vapor deposition is suitable for the case of using a fused-ring aromatic pigment or a perylene pigment as the charge-generating material.

Examples of the solvent used for preparing the coating liquid for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used singly or as a mixture of two or more.

Examples of the method for dispersing particles (e.g., charge-generating material) in the coating liquid for forming the charge generation layer include methods using a media disperser, such as a ball mill, a vibrating ball mill, an attritor, a sand mill, or a horizontal sand mill, or a medialess disperser, such as a stirrer, an ultrasonic disperser, a roll mill, or a high-pressure homogenizer. Examples of the high-pressure homogenizer include a collision-type homogenizer in which a dispersion is formed through liquid-liquid collision or liquid-wall collision under high pressure, and a penetration-type homogenizer in which a dispersion is formed by passing the mixture through a fine flow path under high pressure.

This dispersion is effectively formed when the charge-generating material in the coating liquid for forming the charge generation layer has an average particle size of 0.5 μm or less, preferably 0.3 μm or less, more preferably 0.15 μm or less.

Examples of the method for applying the coating liquid for forming the charge generation layer onto the undercoat layer (or onto the intermediate layer) include common methods, such as a blade coating method, a wire bar coating method, a spray coating method, a dip coating method, a bead coating method, an air knife coating method, and a curtain coating method.

The thickness of the charge generation layer is preferably set, for example, in the range of 0.1 μm or more and 5.0 μm or less, more preferably in the range of 0.2 μm or more and 2.0 μm or less.

### Charge Transport Layer

The charge transport layer is a layer containing at least a charge-transporting material and a binder resin. The charge-transporting material may be a polymer charge-transporting material.

Examples of the charge-transporting material include electron-transporting compounds, such as quinone compounds, such as p-benzoquinone, chloranil, bromanil, and anthraquinone; tetracyanoquinodimethane compounds; fluorenone compounds, such as 2,4,7-trinitrofluorenone; xanthone compounds; benzophenone compounds; cyanovinyl compounds; and ethylene compounds. Examples of the charge-transporting material also include hole-transporting compounds, such as triarylamine compounds, benzidine compounds, arylalkane compounds, aryl-substituted ethylene compounds, stilbene compounds, anthracene compounds, and hydrazone compounds. These charge-transporting materials are used singly or in combination of two or more. The charge-transporting materials are not limited to these compounds.

Examples of polymer charge-transporting materials include known chemical substances having charge-transporting properties, such as poly-N-vinylcarbazole or polysilane. For example, polyester-based polymer charge-transporting materials may be used. The polymer charge-transporting materials may be used singly or together with a binder resin.

Examples of the charge-transporting material or the polymer charge-transporting material include polycyclic aromatic compounds, aromatic nitro compounds, aromatic amine compounds, heterocyclic compounds, hydrazone compounds, styryl compounds, enamine compounds, benzidine compounds, triarylamine compounds (especially triphenylamine compounds), diamine compounds, oxadiazole compounds, carbazole compounds, organic polysilane compounds, pyrazoline compounds, indole compounds, oxazole compounds, isoxazole compounds, thiazole compounds, thiadiazole compounds, imidazole compounds, pyrazole compounds, triazole compounds, cyano compounds, benzofuran compounds, aniline compounds, butadiene compounds, and resins having groups derived from these substances. Specific examples include compounds described in paragraphs 0078 to 0080 in Japanese Unexamined Patent Application Publication No. 2021-117377, paragraphs 0046 to 0048 in Japanese Unexamined Patent Application Publication No. 2019-035900, paragraphs 0052 to 0053 in Japanese Unexamined Patent Application Publication No. 2019-012141, paragraphs 0122 to 0134 in Japanese Unexamined Patent Application Publication No. 2021-071565, paragraphs 0101 to 0110 in Japanese Unexamined Patent Application Publication No. 2021-015223, paragraph 0116 in Japanese Unexamined Patent Application Publication No. 2013-097300, paragraphs 0309 to 0316 in International Publication No. WO 2019/070003, paragraphs 0103 to 0107 in Japanese Unexamined Patent Application Publication No. 2018-159087, and paragraphs 0102 to 0113 in Japanese Unexamined Patent Application Publication No. 2021-148818.

From the viewpoint of charge mobility, the charge-transporting material may contain at least one selected from the group consisting of a compound (D1) represented by formula (D1), a compound (D2) represented by formula (D2), a compound (D3) represented by formula (D3), and a compound (D4) represented by formula (D4).

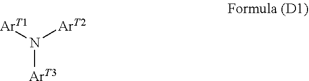

In formula (D1), Ar^{T1}, Ar^{T2}, and Ar^{T3} are each independently an aryl group, —C₆H₄—C(R^{T4})=C(R^{T5})(R^{T6}) or —C₆H₄—CH═CH—CH═C(R^{T7})(R^{T8}). R^{T4}, R^{T5}, R^{T6}, R^{T7}, and R^{T8} are each independently a hydrogen atom, an alkyl group, or an aryl group. When R^{T5} and R^{T6} are aryl groups, the aryl groups may be linked to each other through divalent groups —C(R⁵¹)(R⁵²)- and/or —C(R⁶¹)=C(R⁶²)-. R⁵¹, R⁵², R⁶¹, and R⁶² are each independently a hydrogen atom or a C1-C3 alkyl group.

The groups in formula (D1) may be substituted by a halogen atom, a C1-C5 alkyl group, a C1-C5 alkoxy group, or a substituted amino group substituted by a C1-C3 alkyl group.

From the viewpoint of charge mobility, the compound (D1) is preferably a compound having at least one of an aryl group or —C6H₄—CH═CH—CH═C(R^{T7})(R^{T8}), more preferably a compound (D′1) represented by formula (D′1).

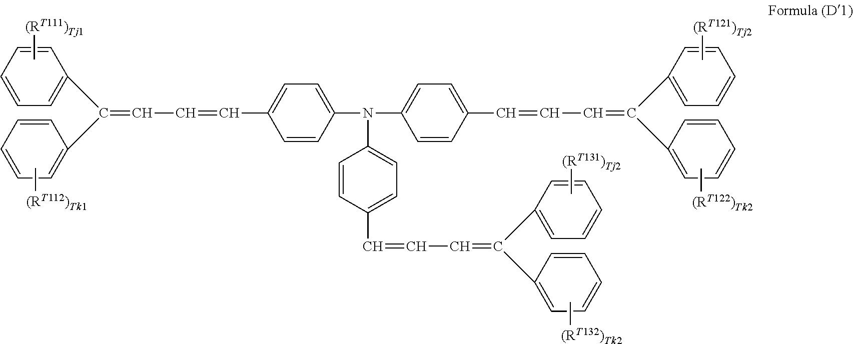

In formula (D′1), R^{T111}, R^{T112}, R^{T121}, R^{T122}, R^{T131}, and R^{T132} are each independently a hydrogen atom, a halogen atom, an alkyl group (e.g., C1-C3 alkyl group), an alkoxy group (e.g., C1-C3 alkoxy group), a phenyl group, or a phenoxy group. Tj1, Tj2, Tj3, Tk1, Tk2, and Tk3 are each independently 0, 1, or 2.

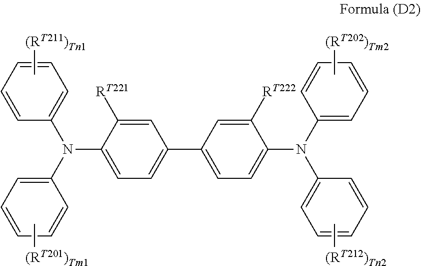

In formula (D2), R^{T201}, R^{T202}, R^{T211}, and R^{T212} are each independently a halogen atom, a C1-C5 alkyl group, a C1-C5 alkoxy group, an amino group substituted by a C1-C2 alkyl group, an aryl group, —C(R^{T21})=C(R^{T22})(R^{T23}), or —CH═CH—CH═C(R^{T24})(R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, a C1-C5 alkyl group, or a C1-C5 alkoxy group. Tm1, Tm2, Tn1, and Tn2 are each independently 0, 1, or 2.

The groups in formula (D2) may be substituted by a halogen atom, a C1-C5 alkyl group, a C1-C5 alkoxy group, or a substituted amino group substituted by a C1-C3 alkyl group.

From the viewpoint of charge mobility, the compound (D2) is preferably a compound having at least one of an alkyl group, an aryl group, or —CH═CH—CH═C(R^{T24})(R^{T25}), more preferably a compound having two of an alkyl group, an aryl group, or —CH═CH—CH═C(R^{T24})(R^{T25})

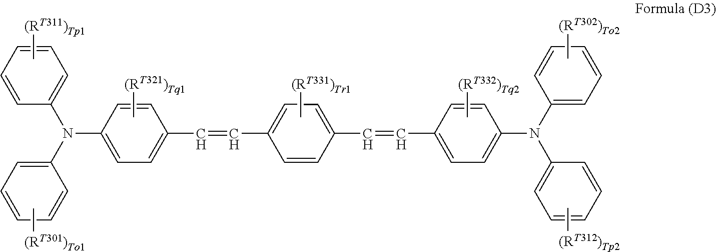

In formula (D3), R^{T301}, R^{T302}, R^{T311}, and R^{T312} are each independently a halogen atom, a C1-C5 alkyl group, a C1-C5 alkoxy group, an amino group substituted by a C1-C2 alkyl group, an aryl group, —C(R^{T31})=C(R^{T32})(R^{T33}), or —CH═CH—CH═C(R^{T34})(R^{T35}). R^{T31}, R^{T32}R^{T33}, R^{T34}, and R^{T35} are each independently a hydrogen atom, an alkyl group, or an aryl group. R^{T321}, R^{T322}, and R^{T331} are each independently a hydrogen atom, a halogen atom, a C1-C5 alkyl group, or a C1-C5 alkoxy group. To1, To2, Tp1, Tp2, Tq1, Tq2, and Tr1 are each independently 0, 1, or 2.

The groups in formula (D3) may be substituted by a halogen atom, a C1-C5 alkyl group, a C1-C5 alkoxy group, or a substituted amino group substituted by a C1-C3 alkyl group.

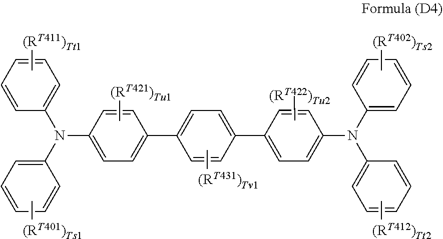

In formula (D4), R^{T401}, R^{T402}, R^{T411}, and R^{T412} are each independently a halogen atom, a C1-C5 alkyl group, a C1-C5 alkoxy group, an amino group substituted by a C1-C2 alkyl group, an aryl group, —C(R^{T41})=C(R^{T42})(R^{T43}) or —CH═CH—CH═C(R^{T44})(R^{T45}). R^{T41}, R^{T42}, R^{T43}, R^{T44}, and R^{T45} are each independently a hydrogen atom, an alkyl group, or an aryl group. R^{T421}, R^{T422}, and R^{T431} are each independently a hydrogen atom, a halogen atom, a C1-C5 alkyl group, or a C1-C5 alkoxy group. Ts1, Ts2, Tt1, Tt2, Tu1, Tu2, and Tv1 are each independently 0, 1, or 2.

The groups in formula (D4) may be substituted by a halogen atom, a C1-C5 alkyl group, a C1-C5 alkoxy group, or a substituted amino group substituted by a C1-C3 alkyl group.

The mass ratio of the charge-transporting material in the charge transport layer is preferably 20 mass % or more and 70 mass % or less, more preferably 25 mass % or more and 60 mass % or less, still more preferably 30 mass % or more and 50 mass % or less.

The charge transport layer contains at least the polyester resin (1) and/or the polycarbonate resin (1) as binder resins.

When the charge transport layer contains the polyester resin (1) as a binder resin, the ratio of the polyester resin (1) relative to the total amount of the binder resins contained in the charge transport layer is preferably 60 mass % or more, more preferably 70 mass % or more, still more preferably 80 mass % or more, yet still more preferably 90 mass % or more. When the polyester resin (1) is used in combination with another resin, the polycarbonate resin (1) may be used as another resin.

When the charge transport layer contains the polyester resin (1) and the polycarbonate resin (1) as binder resins, the mass ratio of the polyester resin (1) to the polycarbonate resin (1) is preferably 95:5 to 50:50, more preferably 90:10 to 55:45, still more preferably 85:15 to 60:40.

The charge transport layer may contain another binder resin other than the polyester resin (1) and the polycarbonate resin (1). Examples of another binder resin include polyester resins other than the polyester resin (1), polycarbonate resins other than the polycarbonate resin (1), methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. These binder resins are used singly or in combination of two or more.

The charge transport layer may contain other known additives. Examples of the additives include antioxidants, leveling agents, anti-foaming agents, fillers, and viscosity modifiers.

The charge transport layer may be formed by any of known forming methods. For example, a coating liquid for forming the charge transport layer is prepared by adding the above components to a solvent, and a coating film of the coating liquid is formed, dried, and heated as needed.

Examples of the solvent used for preparing the coating liquid for forming the charge transport layer include aromatic hydrocarbons, such as benzene, toluene, xylene, and chlorobenzene; ketones, such as acetone and 2-butanone; halogenated aliphatic hydrocarbons, such as methylene chloride, chloroform, and ethylene chloride; and ordinary organic solvents, such as cyclic or linear ethers, such as tetrahydrofuran and ethyl ether. These solvents are used singly or as a mixture of two or more.

Examples of the application method for applying the coating liquid for forming the charge transport layer onto the charge generation layer include common methods, such as a blade coating method, a wire bar coating method, a spray coating method, a dip coating method, a bead coating method, an air knife coating method, and a curtain coating method.

The average thickness of the charge transport layer is preferably 20 μm or more and 50 μm or less, more preferably 25 μm or more and 45 μm or less, still more preferably 30 μm or more and 40 μm or less.

### Single Layer Type Photosensitive Layer

The single layer type photosensitive layer (charge generation/charge transport layer) is a layer containing a charge-generating material, a charge-transporting material, a binder resin, and other optional additives. These materials are the same as the materials described for the charge generation layer and the charge transport layer.

The single layer type photosensitive layer contains at least the polyester resin (1) and/or the polycarbonate resin (1) as binder resins.

When the single layer type photosensitive layer contains the polyester resin (1) as a binder resin, the ratio of the polyester resin (1) relative to the total amount of the binder resins contained in the single layer type photosensitive layer is preferably 60 mass % or more, more preferably 70 mass % or more, still more preferably 80 mass % or more, yet still more preferably 90 mass % or more. When the polyester resin (1) is used in combination with another resin, the polycarbonate resin (1) may be used as another resin.

When the single layer type photosensitive layer contains the polyester resin (1) and the polycarbonate resin (1) as binder resins, the mass ratio of the polyester resin (1) to the polycarbonate resin (1) may be 95:5 to 40:60.

The mass ratio of the charge-generating material in the single layer type photosensitive layer is preferably 0.1 mass % or more and 10 mass % or less, more preferably 0.8 mass % or more and 5 mass % or less.

The mass ratio of the charge-transporting material in the single layer type photosensitive layer is preferably 30 mass % or more and 70 mass % or less, more preferably 35 mass % or more and 65 mass % or less, still more preferably 40 mass % or more and 60 mass % or less.

The single layer type photosensitive layer is formed by the same method as the method for forming the charge generation layer or the charge transport layer.

The average thickness of the single layer type photosensitive layer is preferably 25 μm or more and 50 μm or less, more preferably 28 μm or more and 45 μm or less, still more preferably 30 μm or more and 40 μm or less.

### Protective Layer

The protective layer is disposed on the photosensitive layer as needed. The protective layer is disposed for the purpose of, for example, preventing chemical changes of the photosensitive layer during charging or further improving the mechanical strength of the photosensitive layer.

For this, the protective layer may be composed of a cured film (cross-linked film). Examples of the cured film include layers described below in 1) or 2).

1) A layer composed of a cured film with a composition containing a reactive group-containing charge-transporting material having a reactive group and a charge transportable skeleton in the same molecule (i.e., a layer containing a polymer or cross-linked product of the reactive group-containing charge-transporting material)

2) A layer composed of a cured film with a composition containing a non-reactive charge-transporting material and a reactive group-containing non-charge-transporting material having a reactive group but not having a charge transportable skeleton (i.e., a layer containing the non-reactive charge-transporting material and a polymer or cross-linked product of the reactive group-containing non-charge-transporting material)

Examples of the reactive group of the reactive group-containing charge-transporting material include known reactive groups, such as chain polymerizable groups, an epoxy group, —OH, —OR [wherein R represents an alkyl group], —NH₂, —SH, —COOH, and —SiRQ_{3-Qn}(OR^{Q2})_{Qn} [wherein R^{Q1} represents a hydrogen atom, an alkyl group, or a substituted or unsubstituted aryl group, and R^{Q2} represents a hydrogen atom, an alkyl group, or a trialkylsilyl group. Qn represents an integer of 1 to 3].

The chain polymerizable groups are any functional groups that may undergo radical polymerization and are, for example, functional groups having at least a carbon double bond. Specific examples of the chain polymerizable groups include groups containing at least one selected from vinyl groups, vinyl ether groups, vinyl thioether groups, phenyl vinyl groups, vinyl phenyl groups, acryloyl groups, methacryloyl groups, and derivatives thereof. The chain polymerizable groups may contain at least one selected from vinyl groups, phenyl vinyl groups, vinyl phenyl groups, acryloyl groups, methacryloyl groups, and derivatives thereof due to their high reactivity.

The charge transportable skeleton of the reactive group-containing charge-transporting material may have any structure known in the electrophotographic photoreceptor. Examples of the charge transportable skeleton include skeletons that are derived from nitrogen-containing hole-transporting compounds, such as triarylamine compounds, benzidine compounds, and hydrazone compounds, and that have structures conjugated with nitrogen atoms. The charge transportable skeleton may be a triarylamine skeleton among these.

The reactive group-containing charge-transporting material having a reactive group and a charge transportable skeleton, the non-reactive charge-transporting material, and the reactive group-containing non-charge-transporting material are selected from known materials.

The protective layer may contain other known additives.

The protective layer may be formed by any of known forming methods. For example, a coating liquid for forming the protective layer is prepared by adding the above components to a solvent, and a coating film of the coating liquid is formed, dried, and cured by heating or other processes as needed.

Examples of the solvent used for preparing the coating liquid for forming the protective layer include aromatic solvents, such as toluene and xylene; ketone solvents, such as methyl ethyl ketone, methyl isobutyl ketone, and cyclohexanone; ester solvents, such as ethyl acetate and butyl acetate; ether solvents, such as tetrahydrofuran and dioxane; cellosolve solvents, such as ethylene glycol monomethyl ether; and alcohol solvents, such as isopropyl alcohol and butanol. These solvents are used singly or as a mixture of two or more.

The coating liquid for forming the protective layer may be a solvent-free coating liquid.

Examples of the method for applying the coating liquid for forming the protective layer onto the photosensitive layer (e.g., charge transport layer) include common methods, such as a dip coating method, a lift coating method, a wire bar coating method, a spray coating method, a blade coating method, an air knife coating method, and a curtain coating method.

The thickness of the protective layer is preferably set, for example, in the range of 1 μm or more and 20 μm or less, more preferably in the range of 2 μm or more and 10 μm or less.

### Image Forming Apparatus, Process Cartridge

An image forming apparatus according to the present exemplary embodiment includes: an electrophotographic photoreceptor; a charging device that charges the surface of the electrophotographic photoreceptor; an electrostatic latent image-forming device that forms an electrostatic charge image on the charged surface of the electrophotographic photoreceptor; a developing device that develops the electrostatic latent image on the surface of the electrophotographic photoreceptor by using a developer containing a toner to form a toner image; and a transfer device that transfers the toner image to the surface of a recording medium. The electrophotographic photoreceptor according to the present exemplary embodiment is used as an electrophotographic photoreceptor.

The image forming apparatus according to the exemplary embodiment may be a known image forming apparatus, such as an apparatus including a fixing device that fixes a toner image that has been transferred to the surface of a recording medium; a direct transfer-type apparatus in which a toner image formed on the surface of an electrophotographic photoreceptor is directly transferred to a recording medium; an intermediate transfer-type apparatus in which a toner image formed on the surface of an electrophotographic photoreceptor is first transferred to the surface of an intermediate transfer body, and the toner image, which has been transferred to the surface of the intermediate transfer body, is second transferred to the surface of a recording medium; an apparatus including a cleaning device that cleans the surface of an electrophotographic photoreceptor before charging after transfer of a toner image; an apparatus including a discharging device that discharges the surface of an electrophotographic photoreceptor by irradiating the surface of the electrophotographic photoreceptor with discharging light before charging after transfer of a toner image; and an apparatus including an electrophotographic photoreceptor-heating member for increasing the temperature of an electrophotographic photoreceptor to reduce the relative temperature.

In an intermediate transfer-type apparatus, the transfer device includes, for example, an intermediate transfer body having the surface to which a toner image is transferred, a first transfer device that first transfers the toner image on the surface of the electrophotographic photoreceptor to the surface of the intermediate transfer body, and a second transfer device that second transfers the toner image, which has been transferred to the surface of the intermediate transfer body, to the surface of a recording medium.

The image forming apparatus according to the present exemplary embodiment may be either a dry development-type image forming apparatus or a wet development-type (development type using a liquid developer) image forming apparatus.

In the image forming apparatus according to the present exemplary embodiment, for example, a section including the electrophotographic photoreceptor may have a cartridge structure (process cartridge) that is attachable to and detachable from the image forming apparatus. The process cartridge may be, for example, a process cartridge including the electrophotographic photoreceptor according to the present exemplary embodiment. The process cartridge may include, for example, at least one selected from the group consisting of a charging device, an electrostatic latent image-forming device, a developing device, and a transfer device, in addition to the electrophotographic photoreceptor.

An example of the image forming apparatus according to the present exemplary embodiment will be described below, but the image forming apparatus is not limited to this example. The main parts shown in the figures will be described, and other parts will not be described.

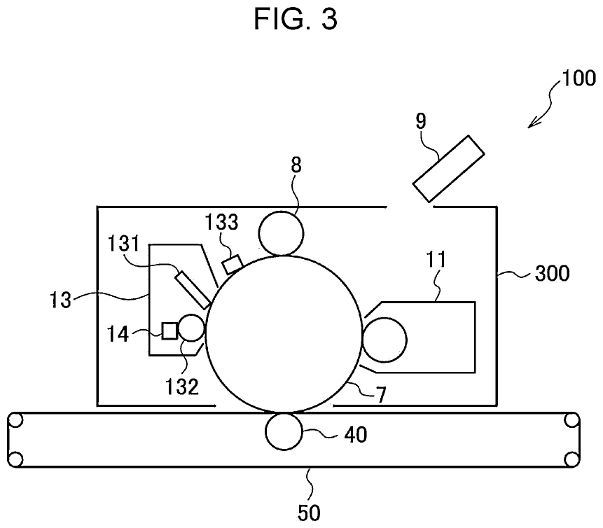

FIG. 3 is a schematic structural view of one example of the image forming apparatus according to the present exemplary embodiment.

Referring to FIG. 3, an image forming apparatus 100 according to the present exemplary embodiment includes a process cartridge 300 including an electrophotographic photoreceptor 7, an exposure device 9 (example electrostatic latent image-forming device), a transfer device 40 (first transfer device), and an intermediate transfer body 50. In the image forming apparatus 100, the exposure device 9 is positioned so as to expose the electrophotographic photoreceptor 7 to light from an opening of the process cartridge 300, the transfer device 40 is positioned so as to face the electrophotographic photoreceptor 7 with the intermediate transfer body 50 between the transfer device 40 and the electrophotographic photoreceptor 7, and the intermediate transfer body 50 is positioned such that part of the intermediate transfer body 50 is in contact with the electrophotographic photoreceptor 7. Although not shown, the image forming apparatus 100 further includes a second transfer device that transfers, to a recording medium (e.g., paper), a toner image that has been transferred to the intermediate transfer body 50. The intermediate transfer body 50, the transfer device 40 (first transfer device), and the second transfer device (not shown) correspond to examples of the transfer device.

The process cartridge 300 in FIG. 3 integrally supports, in a housing, the electrophotographic photoreceptor 7, a charging device 8 (example charging device), a developing device 11 (example developing device), and a cleaning device 13 (example cleaning device). The cleaning device 13 has a cleaning blade (example cleaning member) 131, and the cleaning blade 131 is disposed in contact with the surface of the electrophotographic photoreceptor 7. The cleaning member may be a conductive or insulating fibrous member, instead of the cleaning blade 131. The conductive or insulating fibrous member may be used singly or in combination with the cleaning blade 131.

FIG. 3 illustrates the image forming apparatus including a fibrous member 132 (roll shape) that supplies a lubricant 14 to the surface of the electrophotographic photoreceptor 7 and a fibrous member 133 (flat brush shape) that assists cleaning. These members are disposed as needed.

Each component of the image forming apparatus according to the present exemplary embodiment will be described below.

### Charging Device

Examples of the charging device 8 include contact-type chargers using, for example, a conductive or semi-conductive charging roller, a charging brush, a charging film, a charging rubber blade, and a charging tube. Examples of the charging device 8 also include chargers known per se, such as contactless roller chargers, and scorotron chargers and corotron chargers using corona discharge.

### Exposure Device

Examples of the exposure device 9 include an optical device that exposes the surface of the electrophotographic photoreceptor 7 to light, such as semiconductor laser light, LED light, or liquid crystal shutter light, in a predetermined image pattern. The light source has a wavelength in the region of the spectral sensitivity of the electrophotographic photoreceptor. Semiconductor lasers that are mainly used are near-infrared lasers having an oscillation wavelength of about 780 nm. However, the wavelength is not limited to this, and a laser having an oscillation wavelength in the 600 nm range or a blue laser having an oscillation wavelength of 400 nm or more and 450 nm or less may also be used. A surface-emitting laser light source that may output multiple beams is also effectively used to form color images.

### Developing Device

The developing device 11 is, for example, a typical developing device that performs development using a developer in a contact or non-contact manner. The developing device 11 is not limited as long as the developing device 11 has the function described above, and the developing device 11 is selected according to the purpose. Examples of the developing device 11 include known developing units having a function of attaching a one-component developer or two-component developer to the electrophotographic photoreceptor 7 with a brush, a roller, or other tools. The developing device 11 may use a developing roller that holds a developer on its surface.

The developer used in the developing device 11 may be a one-component developer containing only a toner, or may be a two-component developer containing a toner and a carrier. The developer may be magnetic or non-magnetic. The developer is a known one.

### Cleaning Device

The cleaning device 13 is a cleaning blade-type device including the cleaning blade 131. The cleaning device 13 may be a fur brush cleaning-type device or simultaneous development cleaning-type device instead of a cleaning blade-type device.

### Transfer Device

Examples of the transfer device 40 include contact-type transfer chargers using a belt, a roller, a film, a rubber blade, or the like; and transfer chargers known per se, such as scorotron transfer chargers and corotron transfer chargers using corona discharge.

### Intermediate Transfer Body

The intermediate transfer body 50 may have a belt shape (intermediate transfer belt) containing polyimide, polyamideimide, polycarbonate, polyarylate, polyester, rubber, or the like provided with semiconductivity. The intermediate transfer body may have a drum shape instead of a belt shape.

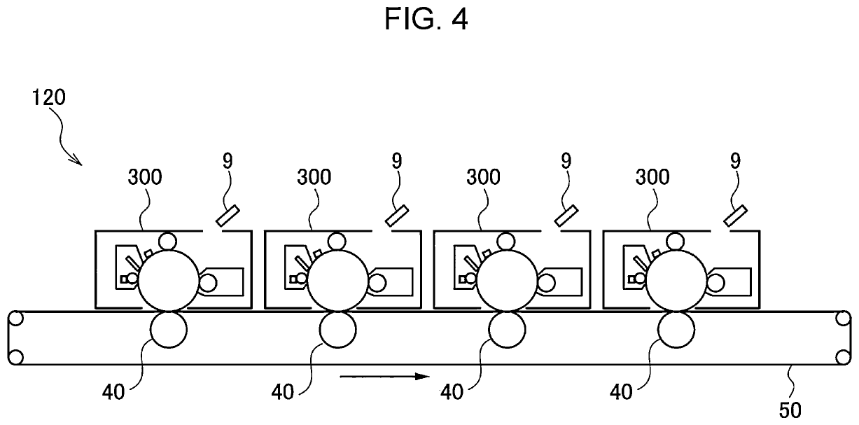

FIG. 4 is a schematic structural view of another example of the image forming apparatus according to the present exemplary embodiment.

An image forming apparatus 120 in FIG. 4 is a tandem-system multicolor image forming apparatus including four process cartridges 300. In the image forming apparatus 120, the four process cartridges 300 are arranged in parallel on an intermediate transfer body 50, and one electrophotographic photoreceptor is used for one color. The image forming apparatus 120 has the same structure as the image forming apparatus 100 except for the tandem system.

### EXAMPLES

Exemplary embodiments of the present disclosure will be described below in detail by way of Examples, but exemplary embodiments of the present disclosure are not limited to these Examples.

In the following description, the units “part” and “%” are on a mass basis, unless otherwise specified.

In the following description, synthesis, treatment, production, and other processes are carried out at room temperature (25° C.±3° C.), unless otherwise specified.

### Synthesis of Polyester Resins

### Synthesis of Polyester Resin (PE-1-1)

In a reaction vessel equipped with a stirrer, 12.64 g of 4,4′-(2-ethylhexylidene)diphenol, 0.123 g of 4-tert-butylphenol, 0.063 g of sodium hydrosulfite, and 250 ml of water are placed to prepare a suspension. While this suspension is stirred at a temperature of 20° C., 4.84 g of sodium hydroxide, 0.200 g of benzyltributylammonium chloride, and 150 ml of water are added and stirred in a nitrogen atmosphere for 30 minutes to prepare an aqueous solution. To this aqueous solution, 200 ml of methylene chloride is added and stirred in a nitrogen atmosphere for 30 minutes, and 12.0 g of 4,4′-biphenyldicarbonyl chloride is then added in the form of powder. After completion of addition, the resulting mixture is stirred at a temperature of 20° C. in a nitrogen atmosphere for two hours so that the polymerization reaction proceeds. The solution after polymerization is subjected to the following purification process.

The solution after polymerization is diluted with 300 ml of methylene chloride, and the aqueous phase is removed. After performing washing with a dilute acetic acid solution and ion exchange water, the resultant is poured into methanol to precipitate the polyester resin. The precipitated polyester resin is separated by filtering and dried at 50° C. The dried polyester resin is dissolved in 900 ml of tetrahydrofuran again and placed in methanol to precipitate the polyester resin. The precipitated polyester resin is separated by filtering, washed with methanol, and then dried at 50° C. to obtain 17.4 g of a white polyester resin. The weight average molecular weight of this polyester resin is 110,000.

### Synthesis of Polyester Resin (PE-1-2)

In a reaction vessel equipped with a stirrer, 13.1 g of 4,4′-(2-ethylhexylidene)diphenol and 8.26 g of triethylamine are placed, and 60 ml of methylene chloride is added to prepare a solution. While this solution is stirred at a temperature of 5° C., 11.33 g of 4,4′-biphenyldicarbonyl chloride is added in the form of powder. After completion of addition, the temperature of the solution is increased to 30° C., and the solution is stirred in a nitrogen atmosphere for two hours so that the polymerization reaction proceeds. The solution after polymerization is subjected to the following purification process.

The solution is separated into an aqueous phase and an organic phase by leaving it to stand, and the aqueous phase is removed. The organic phase is washed with ion exchange water until the pH becomes neutral. Methylene chloride is distilled off from the reaction vessel under reduced pressure to obtain 18.0 g of a polyester resin. The weight average molecular weight of this polyester resin is 110,000.

### Synthesis of Polyester Resins (PE-x-y)

Polyester resins (PE-x-y) shown in Table 1 are synthesized in the same manner as in the synthesis of the polyester resin (PE-1-1) or (PE-1-2) except that the types of monomers subjected to the polymerization reaction are changed, and the amounts of monomers used are changed such that the numbers of moles of the monomers become the same. x is an integer from 2 to 7, and y is an integer from 1 to 2.

The polyester resin (PE-x-1) is a polyester resin produced by the same polymerization method as for the polyester resin (PE-1-1).

The polyester resin (PE-x-2) is a polyester resin produced by the same polymerization method as for the polyester resin (PE-1-2).

### Synthesis of Comparative Polyester Resins

A polyester resin (PE-X1) shown in Table 1 is synthesized in the same manner as in the synthesis of the polyester resin (PE-1-1) except that the types of monomers subjected to the polymerization reaction are changed.

A polyester resin (PE-X2) shown in Table 1 is synthesized in the same manner as in the synthesis of the polyester resin (PE-1-2) except that the types of monomers subjected to the polymerization reaction are changed, and the amounts of monomers used are changed such that the numbers of moles of the monomers become the same.

### Measurement of Acid Value of Polyester Resin

The acid value of each polyester resin is determined by the following measurement method.

The polyester resin is weighed precisely to 50 mg and dissolved in 20 ml of tetrahydrofuran. The resulting solution is used as a titration sample. By using an automatic potentiometric titrator GT-310 (Nittoseiko Analytech Co., Ltd.), 0.01 mL aliquots of 0.005 mol/L potassium hydroxide-isopropyl alcohol solution are added dropwise to the titration sample to determine a titration curve. The inflection point of the titration curve is set as an endpoint, and the titration volume up to the endpoint is calculated. The acid value (mgKOH/g) of the polyester resin is calculated from the titration volume and the mass (50 mg) of the polyester resin subjected to titration. Table 1 shows the results.

In Table 1, 1-A3 and the like are specific examples of the dicarboxylic acid unit (1-A) described above.

In Table 1, A3-2 and the like are specific examples of the dicarboxylic acid unit (A) described above.

In Table 1, B1-4 and the like are specific examples of the diol unit (B) described above.

When two types of dicarboxylic acid units are used, the composition ratio (mol %) is also shown in Table 1.

TABLE 1

| | | | Diol | |
|---|---|---|---|---|
| Polyester | Dicarboxylic Acid | Dicarboxylic Acid | Unit | Acid |
| Resin | Unit (1-A) | Unit (A) | (B) | Value |
| No. | No. | No. | No. | mgKOH/g |
| PE-1-1 | 1-A3 | — | B1-4 | 0.27 |
| PE-1-2 | | | | 5.33 |
| PE-2-1 | 1-A3 | — | B1-2 | 0.34 |
| PE-2-2 | | | | 5.11 |
| PE-3-1 | 1-A4 | — | B4-2 | 0.27 |
| PE-3-2 | | | | 5.30 |
| PE-4-1 | 1-A9 | — | B3-3 | 0.31 |
| PE-4-2 | | | | 5.30 |
| PE-5-1 | 1-A8 | — | B2-8 | 0.34 |
| PE-5-2 | | | | 5.55 |
| PE-6-1 | 1-A3 | A3-2 | B1-2 | 0.39 |
| PE-6-2 | [40 mol %] | [10 mol %] | | 5.96 |
| PE-7-1 | 1-A3 | A1-7 | B2-8 | 0.25 |
| PE-7-2 | [25 mol %] | [25 mol %] | | 5.22 |
| PE-X1 | — | A3-2 | B1-4 | 0.30 |
| PE-X2 | | | | 5.10 |

### Synthesis of Polycarbonate Resins

### Synthesis of Polycarbonate Resins for Present Exemplary Embodiment

Polycarbonate resins (PC-1) to (PC-4) shown in Table 2 are synthesized by the reaction between a diphenol and phosgene.

### Synthesis of Comparative Polycarbonate Resins

A polycarbonate resin (PC-X1) shown in Table 2 is synthesized by the reaction between a diphenol and phosgene.

In Table 2, 1-C3 and the like are specific examples of the structural unit (1-C) described above.

In Table 2, Cb6-3 and the like are specific examples of the structural unit (C) described above.

When two types of structural units are used, the composition ratio (mol %) is also shown in Table 2.

TABLE 2

| Polycarbonate | Structural Unit | Structural Unit | Structural Unit |
|---|---|---|---|
| Resin | (1-C) | (Ca) | (Cb) |
| No. | No. | No. | No. |
| PC-1 | 1-C3 | — | Cb6-3 |
| | [25 mol %] | | [75 mol %] |
| PC-2 | 1-C4 | — | Cb6-3 |
| | [50 mol %] | | [50 mol %] |
| PC-3 | 1-C3 | — | Cb6-4 |
| | [40 mol %] | | [60 mol %] |
| PC-4 | 1-C6 | — | Cb6-3 |
| | [50 mol %] | | [50 mol %] |
| PC-X1 | — | Ca3-2 | Cb6-3 |
| | | [50 mol %] | [50 mol %] |

### Production of Photoreceptor Including Multilayer-Type Photosensitive Layer

### Example S1

### Formation of Undercoat Layer

A cylindrical aluminum tube with an outer diameter of 30 mm, a length of 365 mm, and a wall thickness of 1.6 mm is prepared as a conductive substrate.

Zinc oxide (100 parts) (average particle size: 70 nm, specific surface area: 15 m²/g, available from TAYCA CORPORATION) is mixed with 500 parts of toluene under stirring, and 1.3 parts of a silane coupling agent (product name: KBM-603, available from Shin-Etsu Chemical Co., Ltd., N-2-(aminoethyl)-3-aminopropyltrimethoxysilane) is added and stirred for two hours. Subsequently, toluene is distilled off under reduced pressure, and baking is performed at 120° C. for three hours to obtain zinc oxide having a surface treated with the silane coupling agent.

The surface-treated zinc oxide (110 parts) is mixed with 500 parts of tetrahydrofuran under stirring, and a solution of 0.6 parts of alizarin in 50 parts of tetrahydrofuran is added. The resulting mixture is stirred at 50° C. for five hours. Subsequently, the solids of the mixture are separated by filtering under reduced pressure and dried at 60° C. under reduced pressure to obtain alizarin-added zinc oxide.

A solution is prepared by dissolving 60 parts of alizarin-added zinc oxide, 13.5 parts of a curing agent (blocked isocyanate, product name: Sumidur 3175, available from Sumika Bayer Urethane Co. Ltd.), and 15 parts of a butyral resin (product name: S-LEC BM-1, available from Sekisui Chemical Co., Ltd.) in 68 parts of methyl ethyl ketone, and 100 parts of the solution is mixed with 5 parts of methyl ethyl ketone. The resulting mixture is dispersed for two hours in a sand mill using glass beads having a diameter of 1 mm to obtain a dispersion. To the dispersion, 0.005 parts of dioctyltin dilaurate serving as a catalyst and 4 parts of silicone resin particles (product name: Tospearl 145, available from Momentive Performance Materials Japan LLC) are added to obtain a coating liquid for forming the undercoat layer. The coating liquid for forming the undercoat layer is applied to the outer circumferential surface of the conductive substrate by dip coating and cured by drying at 185° C. for 35 minutes to form an undercoat layer. The average thickness of the undercoat layer is 25 μm.

### Formation of Charge Generation Layer

A mixture composed of 15 parts of hydroxygallium phthalocyanine (with diffraction peaks at least at Bragg's angles (2θ±0.2°) of 7.5°, 9.9°, 12.5°, 16.3°, 18.6°, 25.1°, and 28.3° in an X-ray diffraction spectrum using CuKα characteristic X-rays) serving as a charge generating substance, 10 parts of a vinyl chloride/vinyl acetate copolymer resin (product name: VMCH, available from Nippon Unicar Company Limited) serving as a binder resin, and 200 parts of n-butyl acetate is dispersed for four hours in a sand mill using glass beads having a diameter of 1 mm. To the dispersion, 175 parts of n-butyl acetate and 180 parts of methyl ethyl ketone are added. The resulting mixture is stirred to obtain a coating liquid for forming the charge generation layer. The coating liquid for forming the charge generation layer is applied onto the undercoat layer by dip coating and dried at room temperature (25° C.±3° C.) to form a charge generation layer having an average thickness of 0.25 m.

### Formation of Charge Transport Layer

| | |
|---|---|
| Binder resin: polyester resin (PE-1-1) | 60 parts |
| Charge-transporting material: CTM-1 | 40 parts |

The materials described above are dissolved or dispersed in a solvent mixture of 550 parts of tetrahydrofuran and 50 parts of toluene to obtain a coating liquid for forming a charge transport layer. The coating liquid for forming a charge transport layer is applied onto the charge generation layer by dip coating and dried at a temperature of 150° C. for 40 minutes to form a charge transport layer having an average thickness of 32 m.

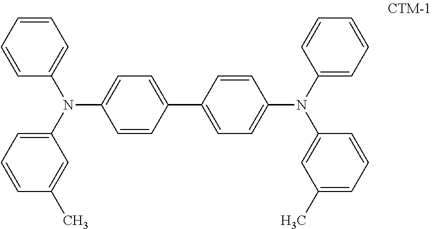 [SMILES: Cc1cccc(N(c2ccccc2)c2ccc(-c3ccc(N(c4ccccc4)c4cccc(C)c4)cc3)cc2)c1]

### Examples to S19 an Comparative Examples S1 to S13

Photoreceptors are produced in the same manner as in Example S1 except that the types and amounts of binder resins in forming the charge transport layer are changed to the specifications described in Table 3.

### Production of Photoreceptor Including Single Layer Type Photosensitive Layer

### Example T1

### Formation of Photosensitive Layer

| | | |
|---|---|---|
| Binder resin: polyester resin (PE-1-1) | 50 | parts |
| Charge-generating material: hydroxygallium phthalocyanine | 1 | part |
| Type V (with diffraction peaks at least at Bragg's | | |
| angles (2θ ± 0.2°) of 7.3°, 16.0°, 24.9°, | | |
| and 28.0° in an X-ray diffraction spectrum | | |
| using CuKα characteristic X-rays) | | |
| Charge-transporting material: CTM-1 | 40 | parts |
| Charge-transporting material: CTM-2 | 9 | parts |

The materials described above are dissolved or dispersed in a solvent mixture of 175 parts of tetrahydrofuran and 75 parts of toluene and subjected to a dispersion treatment for four hours in a sand mill using glass beads with a diameter of 1 mm to obtain a coating liquid for forming a photosensitive layer. The coating liquid for forming the photosensitive layer is applied to the outer circumferential surface of a conductive substrate (a cylindrical aluminum tube with an outer diameter of 30 mm, a length of 365 mm, and a wall thickness of 1.6 mm) by dip coating and cured by drying at a temperature of 150° C. for 60 minutes to form a single layer type photosensitive layer having an average thickness of 36 m.

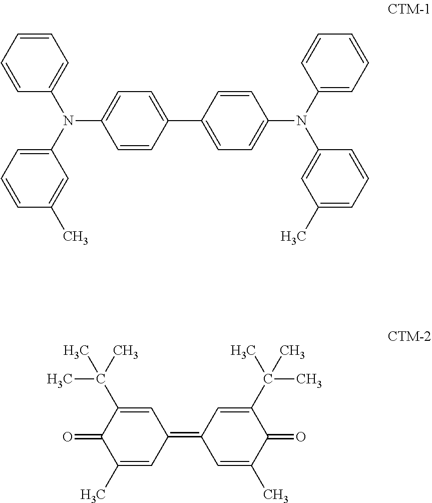 [SMILES: Cc1cccc(N(c2ccccc2)c2ccc(-c3ccc(N(c4ccccc4)c4cccc(C)c4)cc3)cc2)c1 ; CC1=C/C(=C2\C=C(C)C(=O)C(C(C)(C)C)=C2)C=C(C(C)(C)C)C1=O]

### Examples T2 to T8 and Comparative Examples T1 to T5

Photoreceptors are produced in the same manner as in Example T1 except that the types and amounts of binder resins are changed to the specifications described in Table 4.

### Photoreceptor Performance Evaluation

### Wear Resistance

Each photoreceptor is installed into an electrophotographic image forming apparatus (Apeos C5570, FUJIFILM Business Innovation Corp). In a low temperature-low humidity environment with a temperature of 10° C. and a relative humidity of 15%, 20% halftone monochrome images of yellow, magenta, cyan, and black are output on 20,000 sheets of A3 paper in total, 5,000 sheets for each color. Before and after image formation, the thickness of the charge transport layer or the single layer type photosensitive layer is measured at four positions with 900 intervals in the circumferential direction at the center of the photoreceptor in the axial direction. The thickness is measured by using an electromagnetic film thickness meter (Fisher Instruments K.K., PERMASCOPE). The thicknesses at four positions are averaged, and the average thickness after image formation is subtracted from the average thickness before image formation to calculate the wear loss. The wear loss is divided by the number of photoreceptor running cycles to calculate the wear rate (nm/kcy), and the wear rate is classified as described below. The results are shown in Table 3 and Table 4.
A: The wear rate (nm/kcy) is 16 or less.
B: The wear rate (nm/kcy) is more than 16 and 24 or less.
C: The wear rate (nm/kcy) is more than 24.

### Filming

Each photoreceptor is installed into an electrophotographic image forming apparatus (Apeos C6570, FUJIFILM Business Innovation Corp). A black grid chart image with an area coverage of 5% is output on 1,000 sheets of A3 plain paper in a high temperature-high humidity environment with a temperature of 28° C. and a relative humidity of 85%. After image formation, the surface of the photoreceptor is visually observed and classified as described below. The results are shown in Table 3 and Table 4.
A: No filming is observed.
B: Filming is slightly observed in some areas. There are no problems in practical use.
C: Filming is observed. There are problems in practical use.

TABLE 3

| | Charge- | | | | | Polycarbonate | | Charge | Performance | |
|---|---|---|---|---|---|---|---|---|---|---|
| | Transporting | Polyester Resin | | | | Resin | | Transport | Evaluation | |
| | Material | | Amount | | Amount | | Amount | Layer | Wear | |
| | parts by | Type | parts by | Type | parts by | Type | parts by | Acid Value | Resistance | Filming |
| | mass | No. | mass | No. | mass | No. | mass | mgKOH/g | — | — |
| Comparative | 40 | PE-X1 | 60 | PE-X2 | 0 | — | | 0.18 | C | A |
| Example S1 | | | | | | | | | | |
| Comparative | 40 | | 0 | | 60 | | | 3.06 | C | B |
| Example S2 | | | | | | | | | | |
| Example S1 | 40 | PE-1-1 | 60 | PE-1-2 | 0 | — | | 0.16 | A | A |
| Example S2 | 40 | | 48 | | 12 | | | 0.77 | A | A |
| Example S3 | 40 | | 30 | | 30 | | | 1.68 | A | B |
| Example S4 | 40 | | 24 | | 36 | | | 1.99 | A | B |
| Comparative | 40 | | 12 | | 48 | | | 2.60 | A | C |
| Example S3 | | | | | | | | | | |
| Comparative | 40 | | 0 | | 60 | | | 3.20 | A | C |
| Example S4 | | | | | | | | | | |
| Example S5 | 40 | | 50 | | 0 | PC-1 | 10 | 0.14 | A | A |
| Example S6 | 40 | | 15 | | 35 | | 10 | 1.91 | A | B |
| Comparative | 40 | | 0 | | 50 | | 10 | 2.67 | A | C |
| Example S5 | | | | | | | | | | |
| Example S7 | 40 | PE-2-1 | 60 | PE-2-2 | 0 | — | | 0.20 | A | A |
| Example S8 | 40 | | 48 | | 12 | | | 0.78 | A | A |
| Example S9 | 40 | | 30 | | 30 | | | 1.64 | A | B |
| Example S10 | 40 | | 24 | | 36 | | | 1.92 | A | B |
| Comparative | 40 | | 12 | | 48 | | | 2.49 | A | C |
| Example S6 | | | | | | | | | | |
| Comparative | 40 | | 0 | | 60 | | | 3.07 | A | C |
| Example S7 | | | | | | | | | | |
| Example S11 | 40 | PE-3-1 | 60 | PE-3-2 | 0 | — | | 0.19 | A | A |
| Comparative | 40 | | 0 | | 60 | | | 3.18 | A | C |
| Example S8 | | | | | | | | | | |
| Example S12 | 40 | PE-4-1 | 60 | PE-4-2 | 0 | — | | 0.20 | A | A |
| Comparative | 40 | | 0 | | 60 | | | 3.33 | A | C |
| Example S9 | | | | | | | | | | |
| Example S13 | 40 | PE-5-1 | 60 | PE-5-2 | 0 | — | | 0.23 | A | A |
| Comparative | 40 | | 0 | | 60 | | | 3.58 | A | C |
| Example S10 | | | | | | | | | | |
| Example S14 | 40 | PE-6-1 | 60 | PE-6-2 | 0 | — | | 0.15 | A | A |
| Comparative | 40 | | 0 | | 60 | | | 3.13 | A | C |
| Example S11 | | | | | | | | | | |
| Example S15 | 40 | PE-7-1 | 60 | PE-7-2 | 0 | — | | 0.18 | A | A |
| Comparative | 40 | | 0 | | 60 | | | 3.06 | A | C |
| Example S12 | | | | | | | | | | |
| Comparative | 40 | — | | | | PC-X1 | 60 | <0.10 | C | A |
| Example S13 | | | | | | | | | | |
| Example S16 | 40 | | | | | PC-1 | 60 | <0.10 | B | A |
| Example S17 | 40 | | | | | PC-2 | 60 | <0.10 | B | A |
| Example S18 | 40 | | | | | PC-3 | 60 | <0.10 | B | A |
| Example S19 | 40 | | | | | PC-4 | 60 | <0.10 | B | A |

TABLE 4

| | | | | | | | | | Single layer | | |
|---|---|---|---|---|---|---|---|---|---|---|---|
| | Charge | Charge- | | | | | Polycarbonate | | type | Performance | |
| | Generation | Transporting | Polyester Resin | | | | Resin | | Photosensitive | Evaluation | |
| | Layer | Material | | Amount | | Amount | | Amount | Layer | Wear | |
| | parts by | parts by | Type | parts by | Type | parts by | Type | parts by | Acid Value | Resistance | Filming |
| | mass | mass | No. | mass | No. | mass | No. | mass | mgKOH/g | — | — |
| Comparative | 1 | 49 | PE-X1 | 50 | PE-X2 | 0 | — | | 0.15 | B | A |
| Example T1 | | | | | | | | | | | |
| Comparative | 1 | 49 | | 0 | | 50 | | | 2.55 | B | C |
| Example T2 | | | | | | | | | | | |
| Example T1 | 1 | 49 | PE-1-1 | 50 | PE-1-2 | 0 | — | | 0.14 | A | A |
| Example T2 | 1 | 49 | | 30 | | 20 | | | 1.15 | A | A |
| Example T3 | 1 | 49 | | 20 | | 30 | | | 1.65 | A | B |
| Comparative | 1 | 49 | | 0 | | 50 | | | 2.67 | A | C |
| Example T3 | | | | | | | | | | | |
| Example T4 | 1 | 49 | PE-2-1 | 50 | PE-2-2 | 0 | — | | 0.17 | A | A |
| Comparative | 1 | 49 | | 0 | | 50 | | | 2.56 | A | C |
| Example T4 | | | | | | | | | | | |
| Comparative | 1 | 49 | — | | | | PC-X1 | 45 | <0.10 | C | A |
| Example T5 | | | | | | | | | | | |
| Example T5 | 1 | 49 | | | | | PC-1 | 45 | <0.10 | C | A |
| Example T6 | 1 | 49 | | | | | PC-2 | 45 | <0.10 | C | A |
| Example T7 | 1 | 49 | | | | | PC-3 | 45 | <0.10 | C | A |
| Example T8 | 1 | 49 | | | | | PC-4 | 45 | <0.10 | C | A |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrophotographic photoreceptor including:
   a conductive substrate; and
   a multilayer-type photosensitive layer that is disposed on the conductive substrate and has a charge generation layer and a charge transport layer,
   wherein the charge transport layer contains a charge-transporting material and at least one of a polyester resin and a polycarbonate resin that each have a structural unit including a biphenyl represented by formula (1), and
   the charge transport layer has an acid value of 2 mgKOH/g or less:

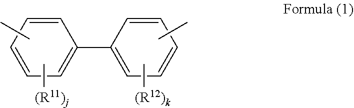

in formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.
(((2))) The electrophotographic photoreceptor according to (((1))), wherein a mass ratio of the charge-transporting material in the charge transport layer is 30 mass % or more and 50 mass % or less.
(((3))) The electrophotographic photoreceptor according to (((1))) or (((2))), wherein the polyester resin has at least one of a dicarboxylic acid unit (1-A) represented by formula (1-A) and a diol unit (1-B) represented by formula (1-B), and
   the polycarbonate resin has a structural unit (1-C) represented by formula (1-C):

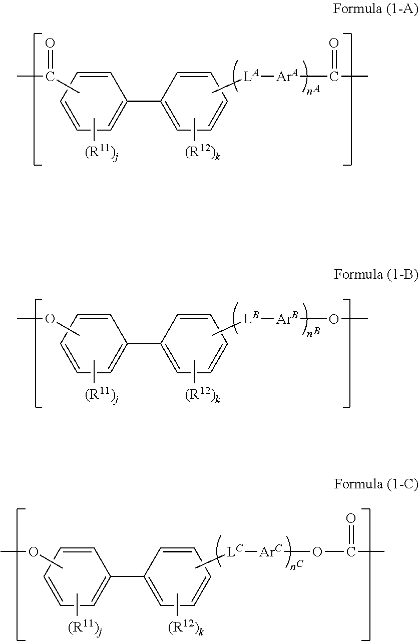

in formula (1-A), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{A} is a single bond or a divalent linking group, Ar^{A} is an optionally substituted aromatic ring, and n^{A} is 0, 1, or 2;
in formula (1-B), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{B} is a single bond or a divalent linking group, Ar^{B} is an optionally substituted aromatic ring, and n^{B} is 0, 1, or 2; and
in formula (1-C), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{C} is a single bond or a divalent linking group, Ar^{C} is an optionally substituted aromatic ring, and n^{C} is 0, 1, or 2.
(((4))) An electrophotographic photoreceptor including:
   a conductive substrate; and
   a single layer type photosensitive layer that is disposed on the conductive substrate,
   wherein the single layer type photosensitive layer contains a charge-transporting material and at least one of a polyester resin and a polycarbonate resin that each have a structural unit including a biphenyl represented by formula (1), and
   the single layer type photosensitive layer has an acid value of 2 mgKOH/g or less:

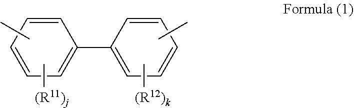

in formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.
(((5))) The electrophotographic photoreceptor according to (((4))), wherein a mass ratio of the charge-transporting material in the single layer type photosensitive layer is 40 mass % or more and 60 mass % or less.
(((6))) The electrophotographic photoreceptor according to (((4))) or (((5))), wherein the polyester resin has at least one of a dicarboxylic acid unit (1-A) represented by formula (1-A) and a diol unit (1-B) represented by formula (1-B), and
   the polycarbonate resin has a structural unit (1-C) represented by formula (1-C):

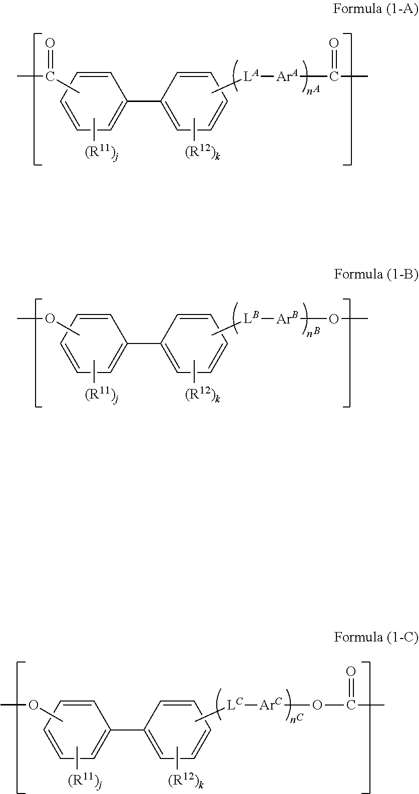

in formula (1-A), j is an integer of 0 or more and 4 or less, j R^{D}'s are each independently a methyl group or an ethyl group, k is an integer of 0 or more and 4 or less, and k R¹²'s are each independently a methyl group or an ethyl group, L^{A} is a single bond or a divalent linking group, Ar^{A} is an optionally substituted aromatic ring, and n^{A} is 0, 1, or 2;
in formula (1-B), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{B} is a single bond or a divalent linking group, Ar^{B} is an optionally substituted aromatic ring, and n^{B} is 0, 1, or 2; and
in formula (1-C), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{C} is a single bond or a divalent linking group, Ar^{C} is an optionally substituted aromatic ring, and n^{C} is 0, 1, or 2.
(((7))) A process cartridge including the electrophotographic photoreceptor according to any one of (((1))) to (((6))),
   wherein the process cartridge is attachable to and detachable from an image forming apparatus.
(((8))) An image forming apparatus including:
   the electrophotographic photoreceptor according to any one of (((1))) to (((6)));
   a charging device that charges a surface of the electrophotographic photoreceptor;
   an electrostatic latent image-forming device that forms an electrostatic latent image on the charged surface of the electrophotographic photoreceptor;
   a developing device that develops the electrostatic latent image on the surface of the electrophotographic photoreceptor by using a developer containing a toner to form a toner image; and
   a transfer device that transfers the toner image to a surface of a recording medium.

What is claimed is:

1. An electrophotographic photoreceptor comprising:
a conductive substrate; and
a multilayer-type photosensitive layer that is disposed on the conductive substrate and has a charge generation layer and a charge transport layer,
wherein the charge transport layer contains a charge-transporting material and at least one of a polyester resin and a polycarbonate resin that each have a structural unit including a biphenyl represented by formula (1), and
the charge transport layer has an acid value of 2 mgKOH/g or less: 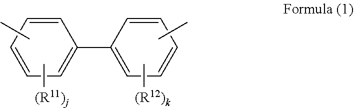
in formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

2. The electrophotographic photoreceptor according to claim 1, wherein a mass ratio of the charge-transporting material in the charge transport layer is 30 mass % or more and 50 mass % or less.

3. The electrophotographic photoreceptor according to claim 1, wherein the polyester resin has at least one of a dicarboxylic acid unit (1-A) represented by formula (1-A) and a diol unit (1-B) represented by formula (1-B), and
the polycarbonate resin has a structural unit (1-C) represented by formula (1-C): 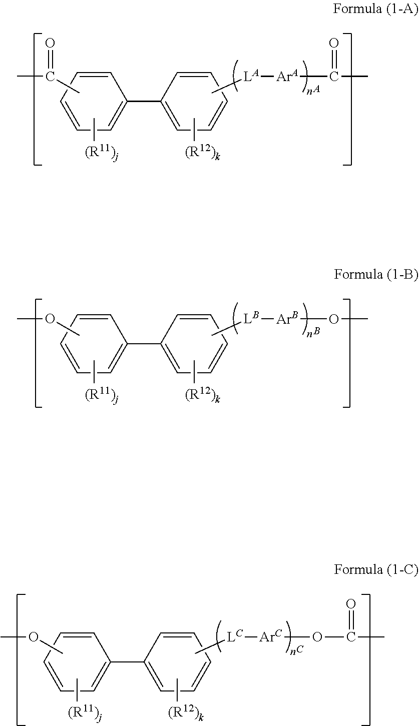
in formula (1-A), j is an integer of 0 or more and 4 or less, j R^{D}'s are each independently a methyl group or an ethyl group, k is an integer of 0 or more and 4 or less, and k R¹²'s are each independently a methyl group or an ethyl group, L^{A} is a single bond or a divalent linking group, Ar^{A} is an optionally substituted aromatic ring, and n^{A} is 0, 1, or 2;
in formula (1-B), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{B} is a single bond or a divalent linking group, Ar^{B} is an optionally substituted aromatic ring, and n^{B} is 0, 1, or 2; and
in formula (1-C), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{C} is a single bond or a divalent linking group, Ar^{C} is an optionally substituted aromatic ring, and n^{C} is 0, 1, or 2.

4. An electrophotographic photoreceptor comprising:
a conductive substrate; and
a single layer type photosensitive layer that is disposed on the conductive substrate,
wherein the single layer type photosensitive layer contains a charge-transporting material and at least one of a polyester resin and a polycarbonate resin that each have a structural unit including a biphenyl represented by formula (1), and
the single layer type photosensitive layer has an acid value of 2 mgKOH/g or less: 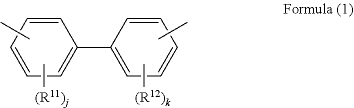
in formula (1), j is an integer of 0 or more and 4 or less, j R¹¹'s are each independently a methyl group or an ethyl group, k is an integer of 0 or more and 4 or less, and k R¹²'s are each independently a methyl group or an ethyl group.

5. The electrophotographic photoreceptor according to claim 4, wherein a mass ratio of the charge-transporting material in the single layer type photosensitive layer is 40 mass % or more and 60 mass % or less.

6. The electrophotographic photoreceptor according to claim 4, wherein the polyester resin has at least one of a dicarboxylic acid unit (1-A) represented by formula (1-A) and a diol unit (1-B) represented by formula (1-B), and
the polycarbonate resin has a structural unit (1-C) represented by formula (1-C): 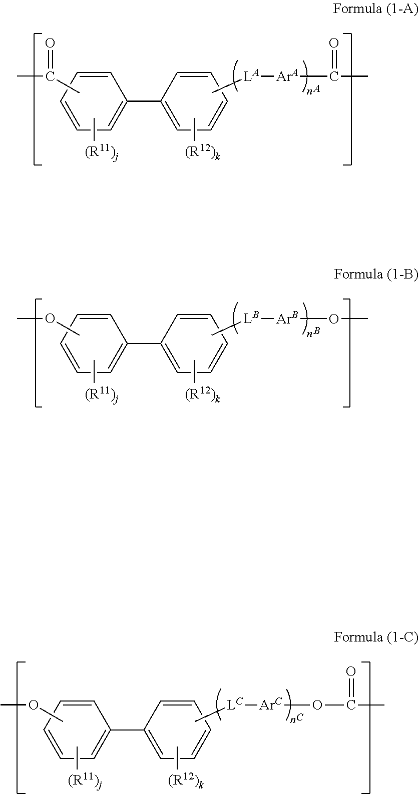
in formula (1-A), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{A} is a single bond or a divalent linking group, Ar^{A} is an optionally substituted aromatic ring, and n^{A} is 0, 1, or 2;
in formula (1-B), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{B} is a single bond or a divalent linking group, Ar^{B} is an optionally substituted aromatic ring, and n^{B} is 0, 1, or 2; and
in formula (1-C), j is an integer of 0 or more and 4 or less, j R¹¹'s are each independently a methyl group or an ethyl group, k is an integer of 0 or more and 4 or less, and k R¹²'s are each independently a methyl group or an ethyl group, L^{C} is a single bond or a divalent linking group, Ar^{C} is an optionally substituted aromatic ring, and n^{C} is 0, 1, or 2.

7. A process cartridge comprising the electrophotographic photoreceptor according to claim 1,
wherein the process cartridge is attachable to and detachable from an image forming apparatus.

8. A process cartridge comprising the electrophotographic photoreceptor according to claim 2,
wherein the process cartridge is attachable to and detachable from an image forming apparatus.

9. A process cartridge comprising the electrophotographic photoreceptor according to claim 3,
wherein the process cartridge is attachable to and detachable from an image forming apparatus.

10. A process cartridge comprising the electrophotographic photoreceptor according to claim 4,
wherein the process cartridge is attachable to and detachable from an image forming apparatus.

11. A process cartridge comprising the electrophotographic photoreceptor according to claim 5,
wherein the process cartridge is attachable to and detachable from an image forming apparatus.

12. A process cartridge comprising the electrophotographic photoreceptor according to claim 6,
wherein the process cartridge is attachable to and detachable from an image forming apparatus.

13. An image forming apparatus comprising:
the electrophotographic photoreceptor according to claim 1;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

14. An image forming apparatus comprising:
the electrophotographic photoreceptor according to claim 2;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

15. An image forming apparatus comprising:
the electrophotographic photoreceptor according to claim 3;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

16. An image forming apparatus comprising:
the electrophotographic photoreceptor according to claim 4;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

17. An image forming apparatus comprising:
the electrophotographic photoreceptor according to claim 5;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.

18. An image forming apparatus comprising:
the electrophotographic photoreceptor according to claim 6;
a charging device that charges a surface of the electrophotographic photoreceptor;
an electrostatic latent image-forming device that forms an electrostatic latent image on the charged surface of the electrophotographic photoreceptor;
a developing device that develops the electrostatic latent image on the surface of the electrophotographic photoreceptor by using a developer containing a toner to form a toner image; and
a transfer device that transfers the toner image to a surface of a recording medium.
